(19) United States
(12) Patent Application Publication
(10) Pub. No.: US 2020/0243231 A1
(43) Pub. Date: Jul. 30, 2020

(54) COMPOSITE MAGNETIC MATERIAL, MAGNET COMPRISING THE MATERIAL, MOTOR USING THE MAGNET, AND METHOD OF MANUFACTURING THE COMPOSITE MAGNETIC MATERIAL

(71) Applicant: CANON KABUSHIKI KAISHA, Tokyo (JP)

(72) Inventors: Daisuke Sasaguri, Yokohama-shi (JP); Naoki Nishimura, Tokyo (JP); Masanobu Ootsuka, Tokyo (JP)

(21) Appl. No.: 16/847,410

(22) Filed: Apr. 13, 2020

Related U.S. Application Data
(63) Continuation of application No. PCT/JP2018/038922, filed on Oct. 19, 2018.

(30) Foreign Application Priority Data
Oct. 20, 2017 (JP) 2017-203059
Oct. 17, 2018 (JP) 2018-196167
Oct. 17, 2018 (JP) 2018-196169

(51) Int. Cl. H01F 1/03; H02K 1/02; H02K 11/33; C01G 49/06; C22C 1/10

(52) U.S. Cl. CPC H01F 1/0302; H02K 1/02; H02K 11/33; C22C 2202/02; C22C 1/1026; C01P 2006/42; C01P 2004/64; C01G 49/06

(57) ABSTRACT

A composite magnetic material includes a soft magnetic phase including a magnetic material containing a ferromagnetic material including Fe or Co as a main component and a plurality of hard magnetic particles present and dispersed in a form of islands in the soft magnetic phase. The hard magnetic particles have an average particle size of 2 nm or more and include a magnetic material containing a ferrimagnetic material or an antiferromagnetic material as a main component while they are present with an average inter-particle distance of 100 nm or less in the soft magnetic phase. The composite magnetic material has excellent magnetic properties and can be made into a lightweight magnet to be used e.g. in a motor of an aircraft.

### CROSS-REFERENCE TO RELATED APPLICATIONS

This application is a Continuation of International Patent Application No. PCT/JP2018/038922, filed Oct. 19, 2018, which claims the benefit of Japanese Patent Application No. 2017-203059, filed Oct. 20, 2017, Japanese Patent Application No. 2018-196167, filed Oct. 17, 2018, and Japanese Patent Application No. 2018-196169, filed Oct. 17, 2018, all of which are hereby incorporated by reference herein in their entirety.

### BACKGROUND OF THE INVENTION

### Field of the Invention

The present invention relates to a composite magnetic material, a magnet containing the material, a motor using the magnet, and a method of manufacturing the composite magnetic material.

### Description of the Related Art

Magnets using rare-earth elements such as neodymium have conventionally been widely used because such Magnets have high residual magnetic flux density and high coercive force and thus excellent magnetic properties. However, since rare-earth elements are rare metals and unevenly distributed on the earth and expensive, there has been an attempt to fabricate high-performance magnets using smaller amounts of rare-earth elements. As an example of such a magnet, a nanocomposite magnet containing a hard magnetic material having a high coercive force and a soft magnetic material having a high saturation magnetic flux density has been known. Since the hard magnetic material having a high coercive force and the soft magnetic material having a saturation magnetic flux density are magnetically coupled through an exchange coupling action, the nanocomposite magnet exhibits excellent magnetic properties.

Japanese Patent Application Laid-Open No. 2011-035006 (hereinafter referred to as Patent Literature 1) discloses a magnetic particle having a core shell structure, including: a core made of a hard magnetic material containing epsilon iron oxide (ε-Fe₂O₃); and a shell made of a soft magnetic material containing alpha iron (α-Fe) and covering the core. This improves the magnetic properties by magnetically coupling the hard magnetic material and the soft magnetic material in the magnetic particle.

Patent Literature 1 describes forming a nanocomposite magnet by densifying the above-described magnetic particles having the core shell structures. In this case, however, even in the case where the above-described magnetic particles are densified by closest packing, voids with a volume ratio of approximately 26% are generated among the particles. As a result of studies, the present inventors found that if a large number of such voids are present, the exchange interaction between the magnetic particles is likely to be blocked. In other words, it is hard to say that Patent Literature 1 has achieved a nanocomposite magnet having sufficiently high magnetic properties.

In addition, in Patent Literature 1, optimization of the particle sizes of the hard magnetic particles and distances between the hard magnetic particles is insufficient in the state of the nanocomposite magnet obtained by densifying the above-describe d magnetic particles. From this fact as well, it is hard to say that Patent Literature 1 has achieved a nanocomposite magnet having sufficiently high magnetic properties.

As described above, in the conventional nanocomposite magnet, the current situation is that the residual magnetic flux density and the coercive force decrease due to blockage of the exchange coupling and variation in the magnetic anisotropy, and sufficient magnet performances have not been achieved.

The present invention has been made in view of the above-described problems, and an object thereof is to provide a composite magnetic material having excellent magnetic properties, a magnet containing the material, a motor using the magnet, and a method of manufacturing the composite magnetic material.

### SUMMARY OF THE INVENTION

A composite magnetic material as one aspect of the present invention includes: a soft magnetic phase including a magnetic material containing a ferromagnetic material including Fe or Co as a main component; and a plurality of hard magnetic particles present and dispersed in a form of islands in the soft magnetic phase, in which the hard magnetic particles have an average particle size of 2 nm or more and include a magnetic material containing a ferrimagnetic material or an antiferromagnetic material as a main component, and an average distance between adjacent two of the hard magnetic particles is 100 nm or less.

In addition, a composite magnetic material as another aspect of the present invention includes: a soft magnetic phase and a plurality of hard magnetic particles present and dispersed in a form of islands in the soft magnetic phase, in which the soft magnetic phase is a continuous body.

Further features of the present invention will become apparent from the following description of exemplary embodiments with reference to the attached drawings.

### BRIEF DESCRIPTION OF THE DRAWINGS

FIG. 1 is a schematic diagram illustrating a structure of a composite magnetic material according to an embodiment of the present invention.

FIG. 2 is a schematic diagram illustrating a structure and a magnetization state in a case where a ferrimagnetic material is used for hard magnetic particles.

FIG. 3A is a diagram illustrating M-H loop of the composite magnetic material according to the embodiment of the present invention.

FIG. 3B is a diagram illustrating a magnetization state of the composite magnetic material according to the embodiment of the present invention.

FIG. 4 is a graph in which optimum values of a particle size and an inter-particle distance of the hard magnetic particles according to the embodiment of the present invention are plotted using a volume fraction of the hard magnetic particles as a parameter.

FIG. 5A is a schematic diagram illustrating a crystal orientation in the embodiment of the present invention.

FIG. 5B is a schematic diagram illustrating a crystal orientation in Comparative Example.

FIG. 6A is a graph illustrating a relation between a volume fraction of the hard magnetic particles and a residual magnetic flux density Br as well as a coercive force Hc according to the embodiment of the present invention.

FIG. 6B is a graph illustrating a relation between a volume fraction and a maximum energy product of the hard magnetic particles according to the embodiment of the present invention.

FIG. 6C is a graph illustrating a relation between the volume fraction and a specific gravity (density) of the hard magnetic particles according to the embodiment of the present invention.

FIG. 7A is a graph illustrating relations between weights and maximum energy products for the magnets of the embodiment of the present invention and Comparative Example.

FIG. 7B is a graph illustrating relations between weights and maximum energy products for conventional magnets including Comparative Example and the embodiment of the present invention.

FIG. 8A is a diagram illustrating M-H loop of a composite magnetic material according to Comparative Example.

FIG. 8B is a diagram illustrating a magnetization state of the composite magnetic material according to Comparative Example.

FIG. 9A is a schematic cross-sectional view of an example of a configuration of a moving part (rotor) using the magnet of the present invention as viewed in a direction of a rotary axis.

FIG. 9B is a schematic cross-sectional view of the moving part (rotor) illustrated in FIG. 9A as viewed in a direction orthogonal to the rotary axis.

FIG. 10 is a schematic cross-sectional view illustrating an example of a configuration of a motor having a moving part (rotor) using the magnet of the present invention.

FIG. 11A is a graph illustrating a time response of a revolutions per minute of the motor when the motor is driven in a certain procedure.

FIG. 11B is a graph illustrating a time response of revolutions per minute of the motor when the motor is driven in another procedure.

FIG. 11C is a graph illustrating a time response of revolutions per minute of the motor when the motor is driven in still another procedure.

FIG. 12A is a graph illustrating time dependences of rotational speeds in Example 1 and Comparative Example 1.

FIG. 12B is a graph illustrating time dependences of consumed currents in Example 1 and Comparative Example 1.

FIG. 13 is a graph illustrating a reduction rate of a motor weight relative to a ratio of a magnet weight.

### DESCRIPTION OF THE EMBODIMENTS

A composite magnetic material of the present invention is a composite magnetic material including: a soft magnetic phase; and a plurality of hard magnetic particles are present and dispersed in a form of islands in the soft magnetic phase. The hard magnetic particles as one aspect of the present invention have an average particle size of 2 nm or more and are present with an average inter-particle distance of 100 nm or less in the soft magnetic phase. The size of the hard magnetic particles and the distance between the islands may be prescribed by deriving optimum values from a result of simulation, for example. In addition, in a composite magnetic material according to another aspect of the present invention, the soft magnetic phase is a continuous body. In this composite magnetic material, it is preferable that there be substantially no non-magnetic materials such as silica or a portion that blocks the magnetic coupling such as voids between the islands. In addition, it is preferable that a plurality of hard magnetic particles be present and dispersed in the form of islands in the soft magnetic phase which has become a continuous body with a reduced variation in easy magnetization axis and also the easy magnetization axes of the hard magnetic particles be aligned with the easy magnetization axes of the soft magnetic phase. It is possible to verify that the soft magnetic phase is a continuous body, for example, by confirming that non-magnetic materials, voids, and the like are reduced and the soft magnetic phase is continuous at least between adjacent two hard magnetic particles when the cross-section of the composite magnetic material is observed with an electron microscope. Note that the portion between adjacent two hard magnetic particles refers to, when one hard magnetic particle is focused on, the portion between the one hard magnetic particle and another hard magnetic particle that is closest to the one hard magnetic particle.

Hereinafter, embodiments of the present invention are described using the drawings. Note that the present invention is not limited to the following embodiments but those obtained by conducting modification, improvement, and the like on the following embodiments based on a common knowledge of a person skilled in the art without departing from the gist of the present invention are also encompassed by the scope of the present invention.

Note that in the Specification of the present application, the magnet includes a so-called permanent magnet, which contains a magnetic material and generates a magnetic field without receiving energy such as current from outside. On the other hand, in the Specification of the present application, the electromagnet is intended to include one that generates a magnetic field when current flows through a coil.

### First Embodiment

(Structure of Composite Magnetic Material)

A composite magnetic material according to the present embodiment has a fine mixed structure in which two phases, that is, a phase of a soft magnetic material (soft magnetic phase) and a phase of a hard magnetic material (hard magnetic particles) are present adjacent to each other on the nm (nanometer) order. Having such a fine mixed structure makes it possible to cause an exchange coupling action to act between the soft magnetic phase and the hard magnetic particles. The exchange coupling action acting between the soft magnetic phase and the hard magnetic particles allows the magnetization switching of the soft magnetic phase to be suppressed by the magnetization of the exchange coupled hard magnetic particles when a magnetic switching field is applied. At this time, the magnetization curve behaves as if the soft magnetic phase and the hard magnetic particles are integrally a single-phase magnet due to the exchange coupling action. For this reason, a magnetization curve involving a large saturation magnetic flux density of the soft magnetic phase and a large coercive force of the hard magnetic particles together is achieved. As a result, it is possible to achieve a high energy product BH max. Note that a magnet configured to cause an exchange coupling action to act between a soft magnetic phase and a hard magnetic phase is known as a nanocomposite magnet and an exchange spring magnet.

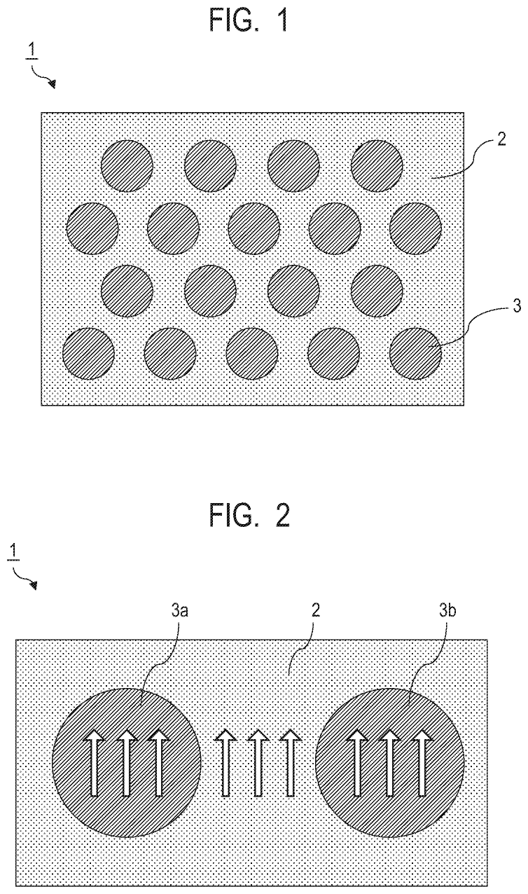

FIG. 1 is a schematic diagram illustrating an example of the structure of the composite magnetic material according to the present embodiment. A composite magnetic material 1 has a sea-island structure in which a plurality of hard magnetic particles 3 are dispersed in the form of islands in a soft magnetic phase 2. The soft magnetic phase of the composite magnetic material of the present embodiment is characterized by being not particles but a continuous body. For this reason, no voids are generated in the soft magnetic phase in principle. As a result, there is substantially no portion where the exchange coupling force between the soft magnetic phase and the hard magnetic particles is blocked. In addition, since the plurality of hard magnetic particles are surrounded by the soft magnetic phase, which is a continuous body, the exchange coupling between the soft magnetic phase and the hard magnetic particles acts effectively. The exchange coupling force between the hard magnetic particles through the soft magnetic phase also acts effectively. Moreover, since the soft magnetic phase is a continuous body, this structure allows the easy magnetization axes to be uniformly aligned in the same direction. This makes it easy to align the magnetization in one direction. Note that the description of one direction or the same direction means that the easy magnetization axes do not largely vary from one another but fall within a certain range of angle, and does not necessarily mean that all the easy magnetization axes are completely in the same direction.

Therefore, it is possible to achieve a high ratio (squareness ratio) between the remanent magnetization and the saturation magnetization in the residual magnetic flux density, the coercive force, and the M-H loop (M indicates the magnetization and H indicates the external magnetic field) of the composite magnetic material 1. Here, the remanent magnetization is a magnetization when the magnetic field is zero and the saturation magnetization is a magnetization saturated by applying a sufficient external magnetic field. For example, it is possible to achieve a squareness ratio of 0.7 or more. Fabricating a magnet in this manner makes it possible to achieve a high maximum energy product BH max.

Note that manufacture variations at the time of fabrication sometimes partially causes voids in the soft magnetic phase or between the soft magnetic phase and the hard magnetic particles. However, it is necessary to suppress the voids in the composite magnetic material 1 to such an extent that does not degrade the performance. Specifically, the volume fraction of voids relative to the volume of the entire composite magnetic material is preferably 20% or less, more preferably 10% or less, and further preferably 5% or less. This makes it possible to achieve the above-described exchange coupling sufficiently effectively.

In addition, there is a case where non-magnetic materials that are neither the soft magnetic material nor the hard magnetic material are partially contained in the composite magnetic material. However, it is necessary to suppress the content of non-magnetic materials to such an extent that does not degrade the performance. Specifically, the volume fraction of non-magnetic materials relative to the volume of the entire composite magnetic material is preferably 10% or less, more preferably 5% or less, and further preferably 2% or less. The non-magnetic materials include materials other than alloys or oxides containing iron group elements (Fe, Co, Ni), and specifically include oxides such as SiO₂, metals having no magnetism such as Cu, Si, and Al, organic substances (resin materials and the like), and the like.

Although an example of the sea-island structure in which the soft magnetic phase, which is a continuous body, is a sea and the hard magnetic material is islands in the shape of particles is described above, a sea-island structure in which the hard magnetic material is a sea and the soft magnetic material is islands in the shape of particles may also be employed.

(Exchange Coupling)

FIG. 2 illustrates how a hard magnetic particle 3a and a hard magnetic particle 3b are exchange coupled through the soft magnetic phase 2 in the composite magnetic material 1 of the present embodiment. The arrows each indicate the magnetization direction and the hard magnetic particles 3a and the hard magnetic particles 3b indicate differential magnetization directions between magnetizations in parallel and opposite to each other of a ferrimagnetic material. As illustrated in FIG. 2, since there are the hard magnetic particles 3 having a high coercive force around the soft magnetic phase 2, the magnetic field required for switching increases due to the exchange coupling force with the hard magnetic particles, and the soft magnetic phase and the hard magnetic particles are switched at the same time by a high magnetic field.

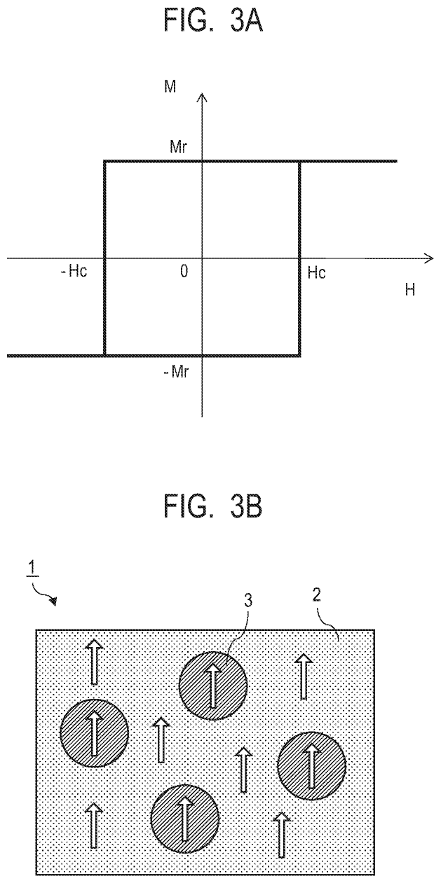

FIG. 3A illustrates a M-H loop of the composite magnetic material of the present embodiment. FIG. 3B illustrates the structure and the magnetization state of the composite magnetic material of the present embodiment in an external magnetic field of zero magnetic field. The magnetization in the zero magnetic field, that is, the remanent magnetization Mr indicates approximately the same value as that at the time of saturation and the squareness ratio is approximately 1, as the magnetization directions of the hard magnetic particles 3 and the soft magnetic phase 2 are aligned in one direction.

(Hard Magnetic Particles)

The hard magnetic particles of the present embodiment contain a hard magnetic material which is a magnetic material having a high coercive force. Specifically, the hard magnetic particles preferably contain a magnetic material containing a ferrimagnetic material or an antiferromagnetic material as a main component. In the present Specification, “contains . . . as a main component” means it contains the material in a mass ratio of 50% or more. These materials have a high coercive force but tend to have a low magnetization. Alternatively, a material having a high magnetocrystalline anisotropy is given as a candidate. As the hard magnetic material, a material having a coercive force of 500 Oe or more is preferable, and a material having a coercive force of 1 kOe or more is more preferable. Moreover, a material having a coercive force of 5 kOe or more is further preferable, and a material having a coercive force of 10 kOe or more is particularly preferable. As the hard magnetic material, a magnetic material containing at least one element selected from the group consisting of Fe, Co, Mn, and Ni is preferably used, and a magnetic material containing Fe is more preferably used. Note that it is preferable that the hard magnetic material substantially do not contain a rare-earth element such as Nd, and it is preferable that the content of the Nd element be 3% by mass or less.

For example, as the ferrimagnetic material, an iron oxide such as ε-Fe₂O₃, γ-Fe₂O₃, Fe₃O₄, or a ferrite magnetic material is used. Among the iron oxides, ε-Fe₂O₃ is desirable because ε-Fe₂O₃ has a particularly high coercive force at room temperature. Note that some of Fe atoms in ε-Fe₂O₃ may be substituted with other metal elements. In particular, some of Fe atoms in ε-Fe₂O₃ may be substituted with at least one element selected from the group consisting of Co, Ni, Al, and Ga. The ferrite magnetic material is, for example, hexagonal ferrite AFe₁₂O₁₉, where A is, for example, an element containing at least one of Ba, Sr, and Pb, or is spinel ferrite BFe₂O₄, where B is, for example, an element containing at least one of Mn, Co, Ni, Cu, and Zn.

The hard magnetic particles may be of a magnetic material having a magnetization smaller than the magnetization of the soft magnetic phase and may be a magnetic material having a magnetization of 0 such as an antiferromagnetic material. The antiferromagnetic material may be NiO, FeMn, MnO, CoO, or the like, but NiO, which has a Neel temperature equal to or more than room temperature, is desirable. However, the magnetization of the entire composite magnetic material is a sum of the products of the respective magnetizations and the respective volume fractions of the hard magnetic particles and the soft magnetic phase. For this reason, a ferrimagnetic material is preferably used, and when hard magnetic particles having a low magnetization are used, the volume fraction of the hard magnetic particles is desirably small to an extent that allows a sufficient coercive force to be obtained.

(Particle Size and Inter-Particle Distance of Hard Magnetic Particles)

The particle size of the hard magnetic particles is made large to an extent that does not lower the coercive force and is also made small to an extent that can maintain the magnetization. Specifically, the average particle size of the hard magnetic particles is preferably 2 nm or more, more preferably 5 nm or more, and further preferably 10 nm or more. The reason for 5 nm or more is that the coercive force of the hard magnetic particles suddenly starts dropping as the particle size becomes smaller than around 5 nm. The reason for 2 nm or more is that around this level is a limit for maintaining the magnetization. Note that the upper limit of the average particle size of the hard magnetic particles is not particularly limited, but is preferably 1000 nm or less, more preferably 500 nm or less, further preferably 300 nm or less, and even further preferably 200 nm or less. The average particle size is particularly preferably 150 nm or less.

The width of the soft magnetic phase, that is, the inter-particle distance between adjacent two hard magnetic particles is desirably 2 nm or more on average. The soft magnetic material and the hard magnetic material are preferably magnetically coupled by an exchange coupling action. For this reason, when the distance from the interface between the island and the sea at which the exchange coupling action acts (hereinafter, referred to as an “exchange coupling distance”) is represented by a, the average distance d between adjacent two islands preferably satisfies d<2a in the composite magnetic material 1. In other words, the average distance between adjacent two islands is preferably twice or less the exchange coupling distance. Specifically, the average distance is preferably 100 nm or less, more preferably 70 nm or less, further preferably 50 nm or less, and particularly preferably 30 nm or less.

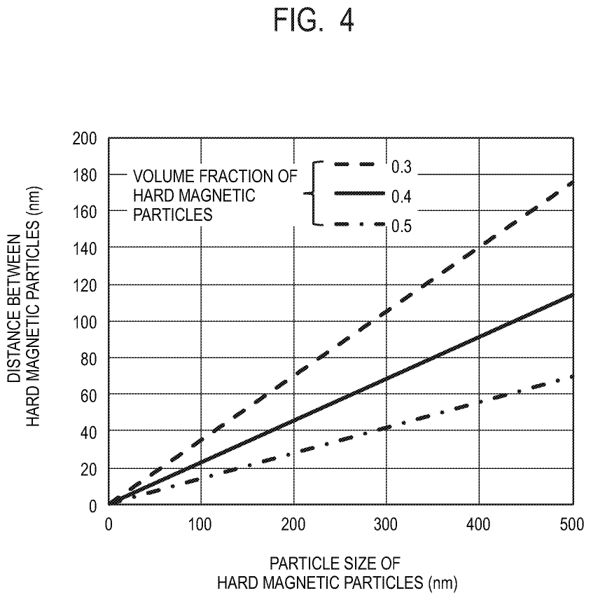

FIG. 4 shows a graph in which optimum values of the particle size of the hard magnetic particles and the inter-particle distance of the hard magnetic particles are plotted using the volume fraction (the hard magnetic particles/(the hard magnetic particles and the soft magnetic phase)) of the hard magnetic particles as a parameter. In accordance with FIG. 4, it is desirable to set the particle size and the inter-particle distance of the hard magnetic particles depending on the volume fraction of the hard magnetic particles.

The average particle size and the average inter-particle distance of the hard magnetic particles can be obtained from an electron microscope image of the cross-section of the composite magnetic material. Specifically, for example, an electron microscope image (electron microscope picture) of the cross-section of the composite magnetic material is obtained using a scanning electron microscope (SEM) and the average particle size and the average inter-particle distance of the hard magnetic particles are measured through image processing based on the obtained image. Note that in this case, it is preferable to obtain an electron microscope image while adjusting the magnification such that at least 10, and preferably several tens to several hundreds, of the hard magnetic particles are present in one electron microscope image. The average particle size and the average inter-particle distance may be calculated by conducting the above-described measurement based on a plurality of fields of view; however, when a statistically sufficient quantity of particles are captured in one field of view, the average particle size and the average inter-particle distance may be calculated based on the one field of view.

Note that if the particle size and the inter-particle distance of the hard magnetic particles satisfy the preferable conditions as described above, the requirement that the soft magnetic phase is a continuous body may be loosened to some extent. That is, even when voids or the like are present in the soft magnetic phase to some extent, if a sufficient exchange coupling action is achieved between the soft magnetic phase and the hard magnetic particles and between adjacent two hard magnetic particles, the composite magnetic material may be appropriate as that of the present invention in some cases. In contrast, if the soft magnetic phase is made a continuous body satisfactorily, the requirements on the particle size and the inter-particle distance of the hard magnetic particles may be loosened to some extent. That is, even when the hard magnetic particles and the inter-particle distance are large to some extent, if the number of portions that block the exchange coupling is sufficiently small and a sufficient exchange coupling action is achieved, the composite magnetic material may be appropriate as that of the present invention in some cases.

(Soft Magnetic Phase)

The soft magnetic material is a material having a saturation magnetic flux density (saturation magnetization) higher than that of the hard magnetic material. The soft magnetic phase preferably contains a ferromagnetic material as a main component. This is because the ferromagnetic material has no portion where magnetizations are parallel and opposite inside the magnetic material, and hence has a large saturation magnetization. The soft magnetic phase particularly preferably contains α-Fe as the main component, but is not limited to this. As the soft magnetic material, a material having a magnetization of 50 emu/g or more is preferable, and a material having a magnetization of 100 emu/g or more is more preferable, and a material having a magnetization of 150 emu/g or more is further preferable.

Specifically, the soft magnetic material preferably contains a single metal of Fe or Co, or an alloy or nitride containing Fe or Co, and more preferably contains a single metal of Fe or a FeM alloy, where M represents at least one element selected from the group consisting of Co, Ni, Al, Ga, and Si, and the composition ratio of each element in the FeM alloy may be selected as desired. Among these, the soft magnetic material more preferably contains α-Fe (α-iron) and is particularly preferably made of α-Fe alone. Note that the soft magnetic material does not necessarily have to be crystalline. In addition, the single metal of Fe may be iron other than α-Fe. The iron (Fe) changes among three forms, α-Fe (α-iron), γ-Fe (γ-iron), and δ-Fe (δ-iron), depending on the temperature. Among these, since α-Fe (α-iron) exhibits magnetization at room temperature, α-Fe (α-iron) is preferably used. Moreover, since iron nitride has a large magnetization, a magnetic material containing iron nitride as the main component may be used as the soft magnetic material. Note that it is preferable that the soft magnetic material substantially do not contain a rare-earth element such as Nd, and the content of the Nd element is preferably 3% by mass or less.

(Crystal Orientation)

In the composite magnetic material of the present embodiment, the easy magnetization axes of the hard magnetic particles are desirably aligned in one direction among the plurality of hard magnetic particles. This makes it possible to align the magnetizations of the hard magnetic particles in the composite magnetic material in the one direction, thus increasing the coercive force of the entire composite magnetic material. This makes it possible to increase the ratio (squareness ratio) between the saturation magnetization and the remanent magnetization of M-H loop and a magnet using this composite magnetic material has a high maximum energy product. It is desirable that the easy magnetization axes of the hard magnetic particles are aligned in one direction among the plurality of hard magnetic particles, but the easy magnetization axes do not necessarily have to be completely aligned and it is satisfactory that the easy magnetization axes aligned to some extent. Specifically, for each of the plurality of hard magnetic particles, the angle made by the direction of the easy magnetization axis of the hard magnetic particle and a certain one direction is preferably 15 degrees or less, more preferably 10 degrees or less, and further preferably 5 degrees or less. In other words, a variation in direction of the easy magnetization axes of the plurality of hard magnetic particles in the composite magnetic material preferably falls within a range of 15 degrees or less. In addition, for the easy magnetization axes of the plurality of hard magnetic particles, a region where the easy magnetization axes of the hard magnetic particles are aligned in one direction preferably accounts for 70% or more in volume ratio relative to the entire composite magnetic material. Note that this volume ratio can be obtained from an electron microscope image of the cross-section of the composite magnetic material like the measurement of the average particle size and the average inter-particle distance of the hard magnetic particles.

In addition, in the composite magnetic material of the present embodiment, it is desirable that the easy magnetization axes of the soft magnetic phase are also aligned in one direction over a wide region surrounding the plurality of hard magnetic particles forming the sea, and it is particularly desirable that the easy magnetization axes of the soft magnetic phase are aligned in the one direction over the entire composite magnetic material. This makes it possible to align the magnetizations of the soft magnetic material forming the soft magnetic phase in the composite magnetic material in the one direction and thus further increase the saturation magnetic flux density (saturation magnetization) of the entire composite magnetic material.

Note that as in the case of the hard magnetic particles, for the alignment of the easy magnetization axes of the soft magnetic phase, it is desirable that the easy magnetization axes are aligned in one direction, but the easy magnetization axes do not necessarily have to be completely aligned and it is satisfactory that the easy magnetization axes are aligned to some extent. Specifically, in the soft magnetic phase within a region containing the plurality of hard magnetic particles, the angle made by the direction of the easy magnetization axis of the soft magnetic phase and a certain one direction is preferably 15 degrees or less, more preferably 10 degrees or less, and further preferably 5 degrees or less. In other words, a variation in direction of the easy magnetization axes of the soft magnetic phase preferably falls within a range of 15 degrees or less. Note that for the alignment of the easy magnetization axes of the soft magnetic phase, at least, the easy magnetization axes are preferably aligned in one direction over the entire soft magnetic phase present between the adjacent two hard magnetic particles. In addition, a region where the easy magnetization axes of the soft magnetic phase are aligned in one direction preferably accounts for 70% or more in volume ratio relative to the entire composite magnetic material. Note that this volume ratio can be obtained from an electron microscope image of the cross-section of the composite magnetic material like the measurement of the average particle size and the average inter-particle distance of the hard magnetic particles.

In addition, in the composite magnetic material of the present embodiment, the directions of the easy magnetization axes of the soft magnetic phase are preferably aligned with the directions of the easy magnetization axes of the hard magnetic particles. Note that it is desirable that both easy magnetization axes are aligned in one direction but it is satisfactory that easy magnetization axes are aligned to some extent as described above. Specifically, a variation in direction of the easy magnetization axes of the soft magnetic phase and the hard magnetic particles preferably falls within a range of 15 degrees or less. In addition, a region where the easy magnetization axes of the soft magnetic phase and the hard magnetic particles are aliened in one direction more preferably accounts for 70% or more in volume ratio relative to the entire composite magnetic material. Note that this volume ratio can be obtained from an electron microscope image of the cross-section of the composite magnetic material like the measurement of the average particle size and the average inter-particle distance of the hard magnetic particles.

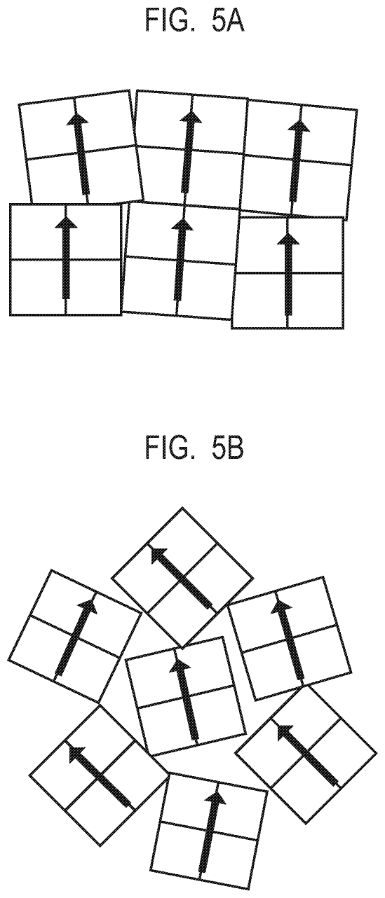

FIGS. 5A and 5B schematically illustrate the crystal structures and the crystal orientations of at least one of the hard magnetic particles and the soft magnetic phase of the composite magnetic material of the present embodiment. Here, rectangles illustrated in FIGS. 5A and 5B indicate crystal structures in a case where a body-centered cubic lattice of α-Fe is used as the soft magnetic phase, and arrows indicate magnetization directions. As illustrated in FIG. 5A, when the crystal orientations are aligned, the soft magnetic phase can transfer an exchanging force acting from the hard magnetic particles and the exchange coupling between the hard magnetic particles is also facilitated. On the other hand, as illustrated in FIG. 5B, when the crystal orientations are not aligned and directed at random, this is not appropriate because it is difficult for the hard magnetic particles to be exchange coupled through the soft magnetic phase.

An example of the crystal structure in the case where ε-Fe₂O₃ is used as the hard magnetic particles is shown below. ε-Fe₂O₃ has a cuboid-shaped (Pna21) crystal structure and its lattice constants are approximately a=5.1 angstrom, b=8.7 angstrom, and c=9.4 angstrom. In this cuboid structure, the c-axis serves as the easy magnetization axis. The crystal directions in the c-axis direction are desirably aligned in one direction, for example, by applying an external magnetic field at the time of fabricating the composite magnetic material. In the case where α-Fe is used as the soft magnetic phase, α-Fe has a crystal structure of a body-centered cubic lattice and its easy magnetization axis is the a-axis, the b-axis, or the c-axis, and it is desirable to align these in one direction. Moreover, in order for the soft magnetic phase to transfer an exchanging force acting from the hard magnetic particles, it is desirable to align the easy magnetization axes of the hard magnetic particles and the soft magnetic phase. For this reason, it is desirable that the c-axis of ε-Fe₂O₃ and any of the a-axis, the b-axis, and the c-axis of the α-Fe are aligned in one direction.

The crystal orientation can be checked directly using a transmission electron microscopy (TEM). In addition, as an alternative to TEM, the crystal orientation may be estimated from the squareness ratio or the like, which can be obtained from a magnetization loop.

Note that the soft magnetic phase and the hard magnetic particles may both be in an amorphous state or may be in a crystalline state, but preferably are in the crystalline state. When the soft magnetic phase and the hard magnetic particles are crystals themselves, this makes it possible to increase the saturation magnetization of the composite magnetic material, making it easier to align the directions of the easy magnetization axes. Even when the soft magnetic phase and the hard magnetic particles are in the amorphous state, it is preferable that the easy magnetization axes of the soft magnetic phase and the hard magnetic particles be aligned in one direction.

(Volume Fraction and Properties)

The composite magnetic material of the present invention is obtained by mixing the hard magnetic particles and the soft magnetic phase, and the magnetic properties of the composite magnetic material depend on the mixing ratio of the hard magnetic particles and the soft magnetic phase and there is an optimum range for the mixing ratio. This optimum range was calculated as described below.

First, the magnetization Mt of the composite magnetic material is expressed by the following Formula (1) using the magnetization Mh of the hard magnetic particles, the magnetization Ms of the soft magnetic phase, the volume fraction Vh of the hard magnetic particles, and the volume fraction Vs of the soft magnetic phase.

Mt=Vh·Mh+Vs·Ms Formula (1)

In addition, the anisotropic energy Kt of the composite magnetic material is expressed by the following Formula (2) using the anisotropic energy Kh of the hard magnetic particles, the anisotropic energy Ks of the soft magnetic phase, the volume fraction Vh of the hard magnetic particles, and the volume fraction Vs of the soft magnetic phase.

Kt=Vh·Kh+Vs·Ks Formula (2)

Moreover, the coercive force Hc of the composite magnetic material is expressed by the following Formula (3).

Hc=2·Mt/Kt Formula (3)

In the SI system, the magnetic flux density B(T) is expressed by the following Formula (4) using the magnetic field H(A/m) and the magnetization M(A/m). Here, in the following Formula (4), to represents the permeability of vacuum.

B=μₒ(H+M) Formula (4)

In Formula (4), with replacement of I=μₒM, the following Formula (5) is obtained and I is expressed in the same unit (T) as the magnetic flux density.

B=μₒH+I Formula (5)

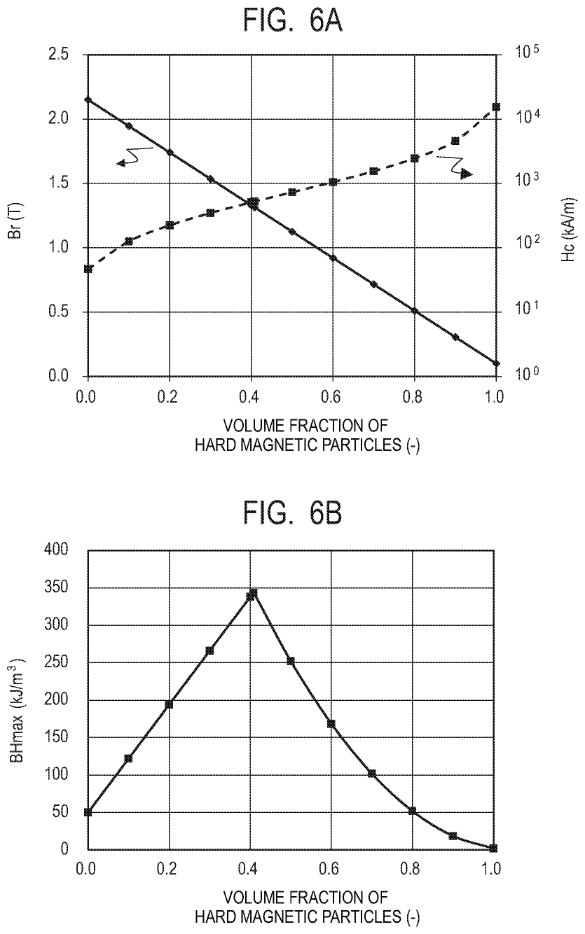

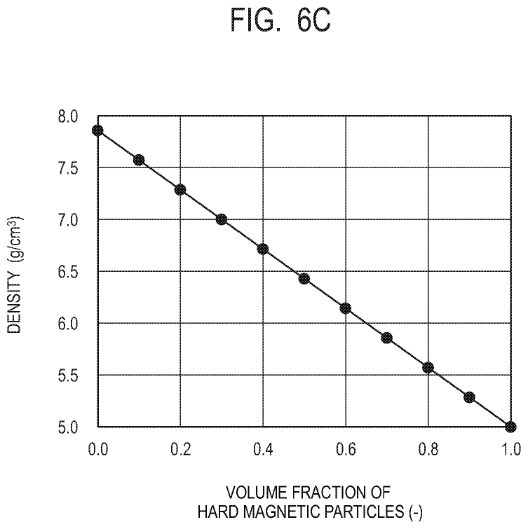

FIGS. 6A and 6B are graphs illustrating relations between the mixing ratio of the hard magnetic particles and the soft magnetic phase, and the residual magnetic flux density Br and the coercive force Hc, as well as the maximum energy product BH max of the composite magnetic material, in the composite magnetic material of the present embodiment. In FIGS. 6A and 6B, the horizontal axis indicates the volume fraction Vh/(Vs+Vh) of the hard magnetic particles, which is the mixing ratio of the hard magnetic material and the soft magnetic phase, where Vs represents the volume of the soft magnetic phase and Vh represents the volume of the hard magnetic particles. In FIG. 6A, the vertical axis indicates the residual magnetic flux density Br and the coercive force Hc, while in FIG. 6B, the vertical axis indicates the maximum energy product BH max.

FIGS. 6A and 6B are based on the result of calculation with the premise that the hard magnetic material forming the hard magnetic particles is ε-Fe₂O₃ and the soft magnetic material forming the soft magnetic phase is α-Fe. Here, the calculation was conducted with the premise that the saturation magnetization and the anisotropic energy of the hard magnetic particles are 0.1 T and 0.77 MJ/m³, respectively, and the saturation magnetization and the anisotropic energy of the soft magnetic material are 2.15 T and 0.05 MJ/m³, respectively. FIG. 6A is the illustration of the dependency of the residual magnetic flux density and the coercive force on the volume fraction of the hard magnetic particles, using these values and Formula (1) to Formula (5). On the other hand, FIG. 6B indicates the maximum energy product BH max based on the result of FIG. 6A.

The maximum energy product BH max is a property that indicates the magnet performance when a magnet is used in a motor or the like. The magnetization Mt when the external magnetic field is 0, that is, the remanent magnetization is represented by Mr, and if the coercive force Hc was larger than Mr/2, BH max was calculated as μₒMr²/4 while if the coercive force Hc was smaller than Mr/2, BH max was calculated as μₒMrHc/2.

From FIG. 6B, it was found that as the mixing ratio of the hard magnetic particles and the soft magnetic phase was shifted, the maximum energy product BH max of the composite magnetic material exhibits the maximum at a certain mixing ratio, which here was 0.4. In the case of FIG. 6B, it is understood to be preferable that the volume fraction of the hard magnetic particles be 0.2 or more and 0.6 or less in order to achieve 170 kJ/m³ or more of BH max and that the volume fraction of the hard magnetic particles be 0.3 or more and 0.5 or less in order to achieve 250 kJ/m³ or more of BH max.

It should be noted that while the above description is of the case of a sintered magnet fabricated by sintering the composite magnetic material, the specific gravity of a bonded magnet fabricated by mixing a magnetic material and a resin is lower than that of the sintered magnet. For example, the specific gravity of a neodymium bonded magnet is approximately ¼ to ⅛ of that of the neodymium sintered magnet. The specific gravity of the bonded magnet depends on the selection of a resin material and the molding method. In a case where the composite magnetic material that is adjusted such that BH max of a sintered magnet becomes 170 kJ/m³ according to the present invention is used, BH max of a bonded magnet becomes 43, 28, 21 kJ/m³ as the specific gravity decreases to ¼, ⅙, ⅛, respectively. In a case where BH max of a sintered magnet of the present invention is 250 kJ/m³, BH max of a bonded magnet becomes 63, 42, 31 kJ/m³ as the specific gravity decreases to ¼, ⅙, ⅛, respectively. For this reason, the maximum energy product BH max of a bonded magnet of the present invention is 21 kJ/m³ or more, favorably 31 kJ/m³ or more, and further desirably 42 kJ/m³ or more.

FIG. 6C, like FIGS. 6A and 6B, illustrates a graph in which the horizontal axis indicates the volume fraction of the hard magnetic particles and the vertical axis indicates the specific gravity of the composite magnetic material of the present embodiment. In the composite magnetic material of the present embodiment, the maximum energy becomes the largest when the volume fraction of the hard magnetic particles is around 0.4. The specific gravity of the composite magnetic material at this time is about 6.7 g/cm³ (hereinafter, the value of the specific gravity, which is essentially non-dimensional, is described with g/cm³, which is the unit for density). The specific gravity of the NdFeB magnet is about 7.6 g/cm³, and the specific gravity of the SmCo magnet is about 8.4 g/cm³. In the magnet of the present invention, in a case where the volume fraction of the hard magnetic particles is 0.4 as an exemplary example, the specific gravity is about 6.7 g/cm³, which means about 12% reduction in weight as compared with a NdFeB magnet, and 20% reduction in weight as compared with a SmCo magnet.

In a case of fabricating a bonded magnet by mixing a magnetic material with a resin, since the specific gravity of a resin is generally lower than the specific gravity of the magnetic material, the specific gravity of the bonded magnet is lower than a sintered magnet obtained by solidifying the magnetic material. In general, when the specific gravity of a bonded magnet is represented by ρb, the volume ratio of the magnetic material is represented by Vm, the specific gravity of the magnetic material in a sintered state is represented by ρm, and the specific gravity of the resin is represented by ρp, Formula (6) is obtained.

ρb=Vm×ρm±(1−Vm)×ρb Formula (6)

For example, in a case where a bonded magnet is fabricated by mixing a composite magnetic material having ρm of 6.7 g/cm³ of the present invention and a resin having ρp of 1 g/cm³ in Vm=0.7 (volume ratio 7:3), the specific gravity ρb of the bonded magnet becomes 5 g/cm³.

The above description is of the case where the volume fraction of the hard magnetic material is 0.4. In a case where the volume fraction of the hard magnetic material is 0.6, the specific gravity ρm of the sintered magnet becomes 6.1 g/cm³. When a bonded magnet is fabricated, Vm is changed within a range of 0.5 to 0.8 depending on the resin material, the molding method, and the usage. In a case where the volume fraction Vh of the hard magnetic material is 0.6 and Vm in Formula (6) is 0.5, 0.7, 0.8, the specific gravity of the bonded magnet becomes 3.6, 4.6, 5.1 g/cm³, respectively. In a case where the volume fraction Vh of the hard magnetic material is 0.4 and Vm in Formula (6) is 0.5, 0.7, 0.8, the specific gravity of the bonded magnet becomes 3.9, 5.0, 5.6 g/cm³, respectively. In a case where the volume fraction Vh of the hard magnetic material is 0.2 and Vm in Formula (6) is 0.5, 0.7, 0.8, the specific gravity of the bonded magnet becomes 4.1, 5.4, 6.0 g/cm³, respectively. The representative performances of a magnet are the maximum energy product and the specific gravity. In the example of FIG. 6B, the maximum energy product is substantially the same when the volume fraction of the hard magnetic material is 0.3 and 0.5, but the specific gravity is smaller when the volume fraction is 0.5.

In view of the above, the specific gravity of the bonded magnet of the present invention is desirably 5 g/cm³ or less.

(Magnetic Powder-Resin Mixed Material)

A product obtained by mixing a magnetic powder containing the composite magnetic material of the present embodiment with a binding agent (binder) (hereinafter, referred to as a magnetic powder-resin mixed material) may be used when a bonded magnet is fabricated. As the binding agent, resin materials such as thermoplastic resins and thermosetting resins, or low-melting-point metals such as Al, Pb, Sn, Zn, and Mg, or alloys containing any of these low-melting-point metals, or the like may be used. The thermoplastic resin includes nylon, polyethylene, EVA (ethylene-vinyl acetate copolymer), and the like, and the thermosetting resin includes epoxy resin, melamine resin, phenol resin, and the like. These magnetic powder-resin mixed materials are in the form of pellets and can be made into magnets using a molding machine.

(Magnet)

The composite magnetic material according to the present embodiment can be molded into a nanocomposite magnet in a desired shape. The nanocomposite magnet according to the present embodiment contains the above-described composite magnetic material. The nanocomposite magnet according to the present embodiment may be a sintered magnet or may be a bonded magnet as described below.

[1] Sintered Magnet

A sintered magnet can be obtained by molding the composite magnetic material according to the present embodiment into a desired shape, and thermally treating the molded body thus obtained under an inert atmosphere or under vacuum. Alternatively, a sintered magnet can be also obtained by sintering the molded body with the plasma activated sintering (PAS) or the spark plasma sintering (SPS). Moreover, an anisotropic sintered magnet can be obtained by molding the composite magnetic material in a magnetic field.

[2] Bonded Magnet

A bonded magnet can be obtained by molding the above-described magnetic powder-resin mixed material into a molded product in a desired shape through injection molding, compression molding, or extrusion molding using a mold like a well-known plastic molding or the like, and magnetizing the molded product thus obtained in a desired magnetization pattern. Note that the magnetization pattern may be magnetized at the same time as the molding. Moreover, an anisotropic bonded magnet can be obtained by molding the composite magnetic material in a magnetic field.

(Magnet Properties)

In the case of using a magnetic material for a magnet, the maximum energy product is preferably 170 kJ/m³ or more, more preferably 200 kJ/m³ or more, and further preferably 250 kJ/m³ or more. From FIG. 6B, in the present embodiment, the volume fraction of the hard magnetic material is preferably 0.18 or more and 0.60 or less, and more preferably 0.30 or more and 0.50 or less.

(Reduction in Weight of Magnet)

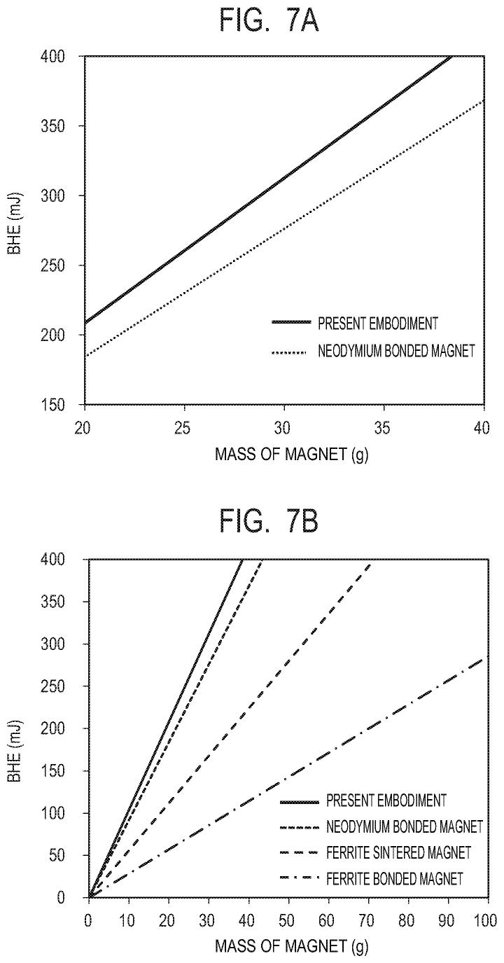

FIG. 7A is a graph illustrating relations between the weight and the maximum energy BHE of a magnet for an example of the magnet according to the present embodiment and a neodymium bonded magnet as Comparative Example. The maximum energy BHE is a value defined by multiplying the maximum energy product BH max by the volume of the magnet to have energy as the unit. The magnet according to the present embodiment is fabricated by mixing the composite magnetic material according to the present embodiment with a resin such that composite magnetic material:resin=7:3 in volume ratio (94:6 in weight ratio), followed by molding. In addition, the neodymium bonded magnet is also fabricated by mixing a neodymium magnetic powder with a resin in the same weight ratio, followed by molding. Note that for comparison, the maximum energy product BH max is set to 70 kJ/m³ for both magnets. As seen from FIG. 7A, according to the present embodiment, it is possible to reduce the weight by approximately 12% relative to the neodymium bonded magnet with the same performance (the same BHE).

FIG. 7B is a graph illustrating also a ferrite sintered magnet and a ferrite bonded magnet in addition to the two examples illustrated in FIG. 7A. A ferrite sintered magnet having a maximum energy product BH max of 28 kJ/m³ and a ferrite bonded magnet having a BH max of 10 kJ/m³ were used respectively as exemplary examples of the magnets. From FIG. 7B, it can be seen that according to the present embodiment, it is possible to further reduce the weight as compared to the ferrite-based magnets with the same performance (the same BHE).

(Motor)

In a case where a magnet is employed for a motor, it is necessary to obtain the maximum energy product with a permeance line taken into consideration in the magnet shape appropriate for the motor. A case where the highest maximum energy product can be obtained with no magnet shape taken into consideration includes a case where a magnet has an elongated shape. In a case where the maximum energy product BH max is highest, the coercive force Hc is equal to Mr/2, and the properties of the magnetic material can be most effectively utilized for the magnet properties. This state is the case where the maximum energy product BH max is highest and the volume fraction of the hard magnetic material is around 0.4 in FIG. 6B.

When the composite magnetic material according to the present embodiment is made into a magnetic powder and sintered and used as a magnet, it is possible to achieve a high remanent magnetization (residual magnetic flux density) and a high coercive force without using any rare-earth element, and obtain a magnet having a high maximum energy product BH max. Moreover, using the magnet according to the present embodiment makes it possible to obtain a motor having a high performance (for example, a high torque) at low costs. In addition, since the reduction in weight of the magnet can be achieved while maintaining the same performance as a neodymium bonded magnet, the weight of the motor can be reduced. Furthermore, in a motor in which the magnet is mounted in a rotating part, the weight of the rotary part is reduced, bringing about advantages such as a low power consumption.

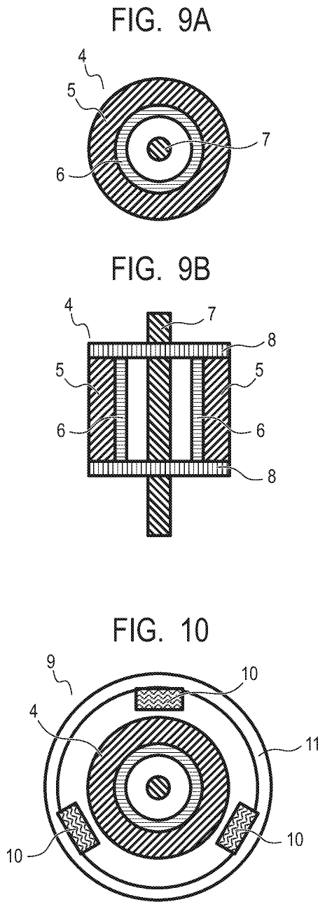

FIGS. 9A and 9B are views illustrating an example of a moving part (rotor) provided with a magnet fabricated using the composite magnetic material of the present invention. The moving part (rotor) 4 has a configuration in which a magnet 5 and a yoke 6 are connected to a shaft 7, which is a central shaft, through lids 8. FIG. 9A is a view as seen from an upper face (in a direction of a rotary axis) and FIG. 9B is a view as seen from a side face (in a direction orthogonal to the rotary axis). FIG. 10 is a view illustrating an example of a motor using the moving part (rotor) 4. The motor 9 includes: electromagnets 10 each including a coil provided on a cover 11; and the moving part (rotor) 4. The motor 9 detects magnetic poles of the magnet 5 with a non-illustrated hall IC, and, depending on the result of the detection, generates a magnetic field by causing current to flow through the electromagnets 10 to rotate the moving part (rotor) 4.

The motor illustrated in FIG. 10 is a type of so-called brushless motors and includes the magnet in the rotary part. A brushless motor having a rotary part inside an electromagnet is an inner rotor brushless motor and a brushless motor having a rotary part outside an electromagnet is an outer rotor brushless motor. The magnet of the present invention can be applied also to an outer rotor brushless motor.

In addition, although in the present Specification, the rotor being part of the motor as the moving part is described as an example of application of the magnet, the magnet of the present invention is not limited to the rotor. For the purpose of reducing the period of acceleration and rotation or reducing the power consumption by means of a reduction in weight, the magnet of the present invention can be applied to, for example, a device in which a moving part does not rotate but moves left and right or up and down or on a circumference. The magnet of the present invention can be applied to, for example, a device in which a plurality of electromagnets are arranged in line and moves a magnet on electromagnets by changing the direction of current in the electromagnets.

### Second Embodiment

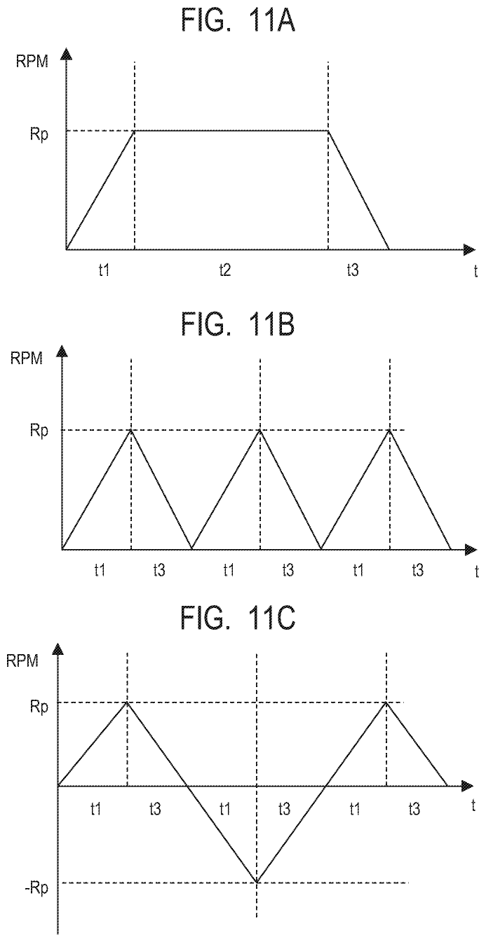

FIGS. 11A to 11C are diagrams illustrating time t responses of the revolutions per minute RPM of the motor. This is a driving sequence that controls the voltage⋅current of the coil of the motor so as to achieve a response as illustrated in FIG. 11A. Such a driving sequence is set in a sequencer that drives such a motor. The configuration including such a sequencer and such a motor is referred to as a motor unit. The revolutions per minute start increasing along with the start of drive, reaches specified revolutions per minute Rp after rise time (activation time) t1. The state of the revolutions per minute Rp is maintained for time t2. The revolutions per minute decreases to zero and the motor stops after fall time t3. During the time until the motor stops from the start of rotation (t1+t2+t3) or the time until the motor reaches and maintains a constant revolutions per minute (t1+t2), it is desirable that a ratio of the duration of the rise time t1 or the fall time t3, or the total of the rise time t1 and the fall time t3 is small because it means that the time taken for activation or stop is shortened as compared with the time of use of the motor.

FIG. 11B illustrates a case where the time t2 during which the specified revolutions per minute Rp is maintained in FIG. 11A is zero and the activation and stop are repeated. In addition, FIG. 11C illustrates a case where the time t2 during which the specified revolutions per minute Rp is maintained is zero, and also where after the motor reaches the revolutions per minute Rp in positive rotation, the rotation is reversed to make the motor reach the revolutions per minute—Rp in reverse rotation. In the cases of FIGS. 11B and 11C, it is desirable that the rise time t1 or the fall time t3, or the total of the rise time t1 and the fall time t3 is small.

For example, the ratio of the time during which the motor is accelerated to rotate and the fall time during 1 cycle time (t1+t2+t3) in FIG. 11A becomes 2t1/(t2+2t1) in a case where t1 and t3 are equal to each other. For example, in the case of t2=2t1, if t1 becomes ½, 1 cycle time becomes ½. In FIG. 11B, 1 cycle time (t1+t3) becomes 2t1 in a case where t1 and t3 are equal to each other. For example, if t1 becomes ½, 1 cycle time becomes ¼. In FIG. 11C, if t1 becomes ½, 1 cycle time (2t1+2t3) becomes ⅛ in a case where t1 and t3 are equal to each other.

As described above, in a case where the motor of the present invention is used, in the drive causing the motor of the present invention to rotate at a constant speed, the time during which the motor is rotated at a constant speed become twice or less the time during which the motor is accelerated to rotate; in the case where the motor is started to rotate and then is stopped immediately after reaching a certain revolutions per minute and in the case where positive rotation and negative rotation of the motor are repeated, the takt time can be reduced, so that the effects become significant.

In the case where a manufacturing device having a machine part that operates to repeat position and negative rotations as in FIG. 11C is used, if the number of times when the machine part reaches a predetermined revolutions per minute during a predetermined time is large, the takt time in the manufacturing step can be shortened, thus improving the productivity. Hence, a motor using the lightweight magnet of the present invention in a moving part (rotor) is useful. The devices having a machine part that operates to repeat position and negative rotations include, for example: devices that are required to have a high torque and short periods of time taken for activation and reverse operation, such as a pulverizer that operates to pulverize an object to be pulverized with a bladed cutter connected to a motor; a stirring device that switches the direction of rotation of a stirring bar when stirring a mixture; an assembling device that perform assembling by rotating a part in one direction to attach the part and then rotating in the reverse direction.

### Third Embodiment

The magnet of the present invention is effective in that the weight of the motor itself can be reduced, even when the magnet is provided in a fixed part (stator part) besides a moving part (rotor part) of the motor.

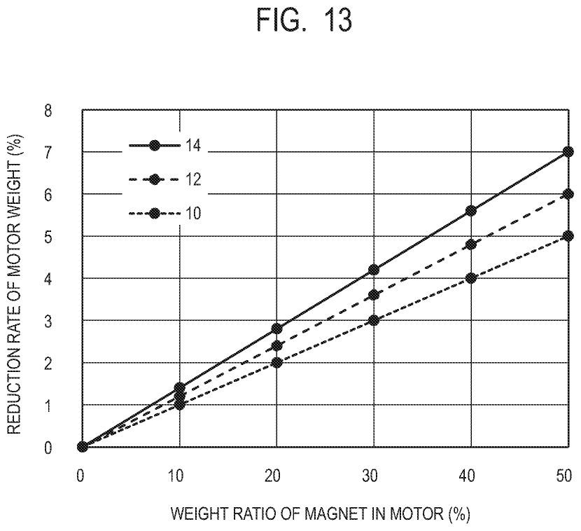

FIG. 13 is a graph illustrating a ratio of the weight of the magnet in a motor and a reduction rate of the weight of the motor itself. Three lines in FIG. 13 indicate cases where the ratios Rρ(%) of the specific gravities of a neodymium magnet, which is Comparative Example, and the magnet of the present invention were calculated as reduction rates in weight using Formula (6) and values Rρ of Formula 6 were 10%, 12%, 14%, respectively:

Rρ=(1−the specific gravity of magnet of the present invention/the specific gravity of the neodymium magnet)×100 Formula (6)

These are obtained by fabricating composite magnetic materials with the volume fractions of the hard magnetic particles set to 0.45, 0.40, 0.35, respectively, as illustrated in FIG. 6C, and setting the specific gravities of the magnets of the present invention to 6.8 g/cm³, 6.7 g/cm³, 6.6 g/cm³, respectively. Note that in the calculation, 7.6 g/cm³ was used as the specific gravity of the neodymium magnet. The reduction rate of motor weight obtained by comparing the motor using the neodymium magnet and the motor using the magnet of the present invention is favorably 1% or more, desirably 2% or more, and further desirably 4% or more. Hence, from FIG. 13, the ratio of the magnet of the present invention in the motor is favorably about 8% or more, desirably about 15% or more, and further desirably about 20% or more.

In recent years, aircraft have been utilized as devices in which a plurality of motors are mounted to rotate propellers. As a representative example, there are aircraft called drones. The drone has 4 to 8 or more motors mounted for rotating propellers. For drones or the usage of drones, there are demands that drones are as small and lightweight as possible, capable of being improved in functions by increasing accessory parts such as cameras and batteries, capable of carrying things as heavy a weight as possible. For this reason, a motor that has properties (torque, revolutions per minute, and the like) required to rotate propellers for flight and as lightweight as possible has been demanded. The motor of the present invention is effective for this purpose.

As a configuration example of a drone, in a case where 4 motors each of 65 g, a frame (including a propeller) of 120 g, a flight controller of 50 g, a camera of 10 g, a camera control unit of 30 g, and a battery of 170 g are used, the weight of the entire drone is 640 g. Here, if the weight reduction rate of the motor is 4%, the entire weight becomes about 630 g. Since the weight of the entire drone is reduced by about 10 g, another camera can be added.

As another configuration example of a drone, in a case where 8 motors each of 65 g, a frame (including a propeller) of 120 g, a flight controller of 50 g, a camera of 10 g, a camera control unit of 30 g, and a battery of 170 g are used, the weight of the entire drone becomes 900 g. Here, if the weight reduction rate of the motor is 2%, the entire weight becomes about 890 g. Since the weight of the entire drone is reduced by about 10 g, another camera can be added. Otherwise, if the weight reduction rate of the motor is 4%, the entire weight becomes about 880 g. Since the weight of the entire drone is reduced by about 20 g, two more cameras can be further added.

Several Comparative Examples to be compared with the above-described embodiment are described.

### Comparative Examples: Particle Sizes and Inter-Particle Distance/Void Ratios of Hard Magnetic Particles

In the technique described in Patent Literature 1, shells containing Fe are formed around ε-Fe₂O₃ particles by subjecting the ε-Fe₂O₃ particles to reduction processing to form the above-described magnetic particles having the core shell structure. In this method, even when the obtained plurality of magnetic particles are densified to form a nanocomposite magnet, it is impossible to make the distance between the ε-Fe₂O₃ particles more than or equal to the particle size of the ε-Fe₂O₃ particles before the reduction processing, and it is difficult to control the particle size of the hard magnetic particles and the distance between the hard magnetic particles. In addition, even when a substance in the form of particles is densified, in a case where the spherical particles are brought into contact with each other, the area of the contact is close to zero and an exchanging force is significantly small. It is known that when a powder, which is an aggregate of particles, is compressed, contact faces are formed between the particles and the void ratio decreases. However, in the case of nanoparticles having a particle size of several hundreds nm or less, reducing the particle size lowers the bulk density of the powder is, making it difficult to reduce the void ratio even with compression. Hence, even when the core shell particles described in Patent Literature 1 are densified, it is impossible to obtain a structure in which a plurality of hard magnetic particles are dispersed in a soft magnetic phase which is a continuous body unlike the present embodiment, leaving a large number of voids

### Comparative Example: M-H Loop

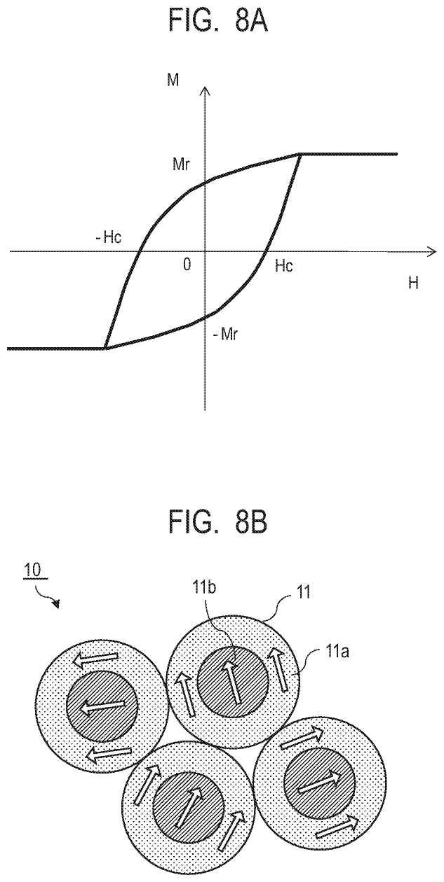

FIG. 8A is a diagram illustrating a M-H loop showing a relation between magnetization M and magnetic field H in a case where a magnet is fabricated with a core shell structure as Comparative Example. FIG. 8B is a diagram illustrating the structure and the magnetization state of a magnet material 10 containing a core shell-type magnetic material 11 of Comparative Example in a zero magnetic field. Here, the core shell-type magnetic material 11 has a core 11b containing a hard magnetic material and a shell 11a containing a soft magnetic material. In Comparative Example, the directions of magnetizations of the respective core shell structures tend to be aligned at random in the zero magnetic field. For this reason, the remanent magnetization Mr becomes significantly smaller than the saturation magnetization, so that the squareness ratio (the ratio between the remanent magnetization and the saturation magnetization) becomes small.

(Method of Manufacturing Composite Magnetic Material)

Next, the steps of the method of manufacturing a composite magnetic material according to the present embodiment are described.

[1] Step of Uniformly Dispersing Hard Magnetic Particles in Solution

This step is a step for uniformly dispersing hard magnetic particles in the state of a composite magnetic material. First, hard magnetic particles are put into an aqueous solution. To prevent the hard magnetic particles from being aggregated to increase in particle size, glass beads are put into the aqueous solution, followed by agitating with a planetary bead mill. In this way, the aggregated state is eliminated to obtain a particle size distribution close to that of the original particles (primary particles). Further, the aqueous solution is filtrated using a filter to remove a large particle size and make the particle size uniform.

[2] Step of Obtaining Dispersion by Dispersing Hard Magnetic Material Particles into Solution Containing Ions Containing Transition Metal Element (at Least One Transition Metal Element Contained in Soft Magnetic Materials)

This step prepares a dispersion obtained by dispersing hard magnetic particles into a solution containing ions containing a transition metal element. In the present embodiment, the soft magnetic material in the composite magnetic material contains a transition metal element, and in this step, a solution of ions containing the transition metal element is prepared. The transition metal element is preferably at least one selected from the group consisting of Fe, Co, Mn, and Ni as described above. Preferably used as the solution is, for example, an aqueous solution of iron(II) chloride, iron(III) chloride, iron(III) sulfate, iron(III) nitrate, or the like in the case where the transition metal element is Fe.

In this step, a dispersion is obtained by dispersing hard magnetic particles in the above-described solution. At this time, it is possible to put the above-described ions into an aqueous solution in which hard magnetic particles have been dispersed in advance in a first step as described above or to disperse hard magnetic particles into a solution that contains the above-described ions as described above.

[3] Step of Precipitating Particles Containing Transition Metal Element by Adding Additive to Dispersion

In this step, by adding an additive to the above-described dispersion to react the above-described ions, thereby precipitating particles or a precipitate containing the transition metal element. In the above-described step [2], since the hard magnetic particles are dispersed in the dispersion, the above-described ions are present around the hard magnetic particles in such a manner as to surround the hard magnetic particles in the dispersion. In this state, the ions are reacted, so that particles or precipitate containing the transition metal element in the ions precipitate. For this reason, particles or precipitate are or is precipitated in such a manner as to surround the hard magnetic particles. In this way, a mixture having a structure in which a plurality of hard magnetic particles are dispersed in the form of islands in a precipitate group containing the transition metal element is obtained. At this time, by sufficiently dispersing the hard magnetic particles in step [2], it is possible to enhance the dispersion of the hard magnetic particles in the mixture and also to adjust the distance between the hard magnetic particles.

As the additive, a reductant or a basic solution is preferably used. Using a reductant as the additive makes it possible to reduce the ions containing the transition metal element to lower the valence of the transition metal element allowing for precipitation. Appropriately selecting a reductant makes it possible to directly precipitate a single metal or an alloy containing the transition metal element. For example, adding NaBH₄, which is a reductant, as the additive to a dispersion in which hard magnetic particles (ε-Fe₂O₃ or the like) have been dispersed in an aqueous solution of iron(II) chloride makes it possible to reduce iron(II) chloride to iron and to precipitate fine particles of α-Fe around the hard magnetic particles.

Note that in the precipitation of α-Fe fine particles, the particle size can be changed by changing the conditions for adding a reductant. For example, a smaller droplet size of the reductant to be added leads to a finer region where the reduction reaction occurs, resulting in a smaller particle size of the α-Fe particles. In addition, for example, in the case where an iron(II) chloride solution is used, when a reductant is added, the particle size can be changed by changing the temperature. The particle size of the α-Fe particles can be reduced by increasing the temperature of the solution. In the fabrication of the composite magnetic material, either a reduction in droplet size of the reductant or an increase in temperature of the iron ion solution may be selected, or both of them may be simultaneously selected, which may be selected depending on a necessary size of the α-Fe particles.

In addition, in the precipitation of the α-Fe fine particles, the particle size can be changed by changing the solvent conditions of the ion solution containing a transition metal element. For example, it is possible to reduce the particle size of the α-Fe particles by adding a reductant after iron(II) chloride is dissolved not into water but into methanol, which is an organic solvent. The reason why it is possible to reduce the particle size in this way is not clear. However, we consider that since an organic solvent has an effect of reducing the surface energy of α-Fe particles at the time of precipitation, this allows for a reduction in particle size. Organic solvents that have an effect of reducing the surface energy of α-Fe particles, that is, have a favorable wettability with α-Fe include, for example, methanol, ethanol, 2-propanol, acetone, dimethyl sulfoxide, tetrahydrofuran, ethylene glycol, diethylene glycol, and the like. One of these solvents may be selected or any of these solvents may be used as a mixture as necessary. However, solvents such as acetone and dimethyl sulfoxide are not efficient because these solvents have a property that part of them is reduced by a reductant. In the fabrication of the composite magnetic material, in the case where an organic solvent is used as a solvent for an ion solution containing a transition metal element, it is preferable to use organic solvents also as a dispersion solvent for dispersing the hard magnetic particles and a solvent for dissolving a reductant, and it is also preferable to conduct a dehydration process and a dissolved oxygen removal process in advance.

In a case where soft magnetic particles such as α-Fe particles and hard magnetic particles such as ε-Fe₂O₃ particles are mixed to be prepared, the soft magnetic particles tend to be aggregated together, so that the particle size of the soft magnetic particles increases beyond the range within which the exchange coupling of the ε-Fe₂O₃ particles acts. However, the present method is capable of avoiding this. The reduction from a dispersion in which iron has been dissolved as ions to iron may be conducted directly using a reductant or may be conducted by first adjusting pH of the dispersion by adding a basic solution as an additive to precipitate particles or a precipitate and thereafter reducing the particles or the precipitate.

That is, by using a basic solution, typically ammonia water, as an additive, it is possible to change pH of the dispersion to react the above-described ions and hydroxide ions, for example, to precipitate a precursor containing the transition metal element. For example, in a case where ions containing the transition metal element is Fe²⁺ or Fe³⁺, it is possible to precipitate iron hydroxide (Fe(OH)₃ and the like), triiron tetraoxide (Fe₃O₄) and the like, by adding ammonia water.

For example, ammonia water is added to the dispersion containing an aqueous solution of iron(III) nitrate to precipitate iron hydroxide (Fe(OH)₃) to surround the hard magnetic particles. Thereafter, the iron hydroxide (Fe(OH)₃) can be reduced to iron (α-Fe and the like) by conducting thermal treatment in a reduction atmosphere. Similarly, it is possible to add ammonia water to an iron(II) chloride solution to precipitate triiron tetraoxide (Fe₃O₄) and reduce triiron tetraoxide (Fe₃O₄) to irons by conducting thermal treatment in a reduction atmosphere. Note that this thermal treatment may also be used as a thermal treatment step to be described later.

[4] Drying⋅Thermal Treatment Step

After a sea portion of the soft magnetic material is formed around the plurality of hard magnetic particles, the aqueous solution is immediately replaced with ethanol. This is for preventing the soft magnetic material such as iron from being oxidized. After that, ethanol is removed by drying.

In this step, thermal treatment is applied to the obtained mixture powder to transform the soft magnetic material into a continuous body. Specifically, the soft magnetic material obtained by the above-described step is in the form of particles or contains voids and the like. In view of this, thermal treatment is conducted in this step to melt or sinter the particles together, so that the soft magnetic material is transformed into a continuous body to form a soft magnetic phase in the form of a sea. At this time, the thermal treatment may be conducted after the above-described mixture is compression-molded, or the compression molding may be conducted after the thermal treatment, or the thermal treatment may be conducted during the compression molding. The thermal treatment is preferably conducted under an inert gas atmosphere, under a reduction atmosphere, or under vacuum, particularly in a case where the soft magnetic material is an easily oxidizable material such as iron.

On the other hand, in a case where the hard magnetic material is a material whose magnetic properties are degraded by a high temperature such as ε-Fe₂O₃, it is preferable to sinter a molded body by plasma activated sintering (PAS), spark plasma sintering (SPS), pulse electric current sintering (PECS), or the like. The plasma activated sintering and the spark plasma sintering are sintering methods in which thermal treatment is conducted during compression molding. The materials of the die for compression molding used for these methods are generally categorized into cemented carbides, typified by tungsten carbide, and graphite carbon. Graphite carbon is preferable from the viewpoint of its capability of following sintering set temperature associated with a high electric resistance and costs. Although it is difficult to say in general because the maximum value and the minimum value of the preferable range of the compression molding pressure in sintering are affected by the specification of a used device and the specification of a used die, the range of the compression molding pressure is preferably from 10 MPa to 500 MPa. If the compression molding pressure during sintering is set lower than 10 MPa, the contact between the sample and the die set sometimes becomes insufficient, so that current locally flows and the molded body is not heated entirely. On the other hand if the compression molding pressure is set higher than 500 MPa, there is a risk that the die is broken. The compression molding pressure is more preferably from 20 MPa to 200 MPa. In addition, the sintering temperature during the compression molding is preferably from 60° C. to 250° C. and more preferably selected from a range from 70° C. to 150° C. If the sintering temperature during the compression molding is less than 60° C., the soft magnetic material is unlikely to become a continuous body. If the sintering temperature during the compression molding is more than 250° C., the magnetic properties of ε-Fe₂O₃ as the hard magnetic material are degraded. The “sintering temperature” mentioned herein is a monitored temperature by a thermocouple inserted in a die and is different from the temperature of the sample itself in a precise sense. Next, the temperature increase rate is preferably selected from a range from 10° C./min to 200° C./min, and more preferably selected from a range from 20° C./min to 100° C./min. If the temperature increase rate is less than 10° C./min, this is not preferable because a time during which ε-Fe₂O₃ as the hard magnetic material is exposed to a high temperature becomes long. If the temperature increase rate is higher than 200° C./min, the soaking of the sample becomes insufficient, possibly causing unevenness in sintering temperature. In addition, although it is difficult to say in general because the holding time at the sintering reached temperature is affected by the sintering temperature⋅compression molding pressure, the holding time is preferably 0 minutes or more and 10 minutes or less and more preferably 0 minutes or more and 3 minutes or less. The “0 minutes” mentioned herein means that the holding time is substantially not provided and cooling is started immediately after the sintering reached temperature is reached.

In a case where ε-Fe₂O₃ is used as the hard magnetic material, the ε-Fe₂O₃ particles can be relatively easily synthesized by generating nanoparticles of iron oxide or iron hydroxide using a chemical process in the solution and heating the nanoparticles thus generated at an oxidizing atmosphere. As the chemical process in the solution, the reverse micelle method, the sol-gel method, or the like using iron(III) nitrate enneahydrate as a starting raw material can be used, for example. Note that in the step of synthesizing ε-Fe₂O₃ particles, the step of coating the surface of the ε-Fe₂O₃ particles with silica (SiO₂) may be added.

### EXAMPLES

Hereinafter, the present invention is described in more detail using Examples, but the present invention is not limited to the following Examples. Note that “%” used below is all based on mass unless otherwise particularly specified.

### Example 1

In Example 1, a composite magnetic material having a sea-island structure in which Fe was a sea and ε-Fe₂O₃ particles were islands was fabricated by dispersing ε-Fe₂O₃ particles into a solution in which iron(II) chloride hydrate (FeCl₂.4H₂O) was dissolved, and precipitating Fe by adding NaBH₄, which is a reductant.

(Fabrication of ε-Fe₂O₃ Particles)

The ε-Fe₂O₃ particles, which is the hard magnetic material, were fabricated by the following procedure. (1) First, two types of micelle solutions (a micelle solution (A) and a micelle solution (B)) were prepared as described below.

(1-1) First, 30 mL of pure water, 92 mL of n-octane, and 19 mL of 1-butanol were put into a reaction vessel and were mixed. Then, 6 g of iron(III) nitrate enneahydrate (Fe(NO₃)₃.9H₂O) was added and sufficiently dissolved while stirring. Next, cetyltrimethylammonium bromide as a surfactant was added to the solution in such an amount that the molar ratio, which is expressed by (the mole number of the pure water)/(the mole number of the surfactant), became 30, and was dissolved in the solution by stirring. In this way, the micelle solution (A) was obtained.

(1-2) First, 10 mL of 28% ammonia water was mixed and stirred with 20 mL of pure water in another reaction vessel, and thereafter, 92 mL of n-octane and 19 mL of 1-butanol were further added, followed by stirring well. Next, cetyltrimethylammonium bromide was added as a surfactant to the solution in such an amount that the molar ratio, which is expressed by (the mole number of (the pure water+water in the ammonia water))/(the mole number of the surfactant), became 30, and was dissolved into the solution by stirring. In this way, the micelle solution (B) was obtained.

(2) The micelle solution (B) was added dropwise to the micelle solution (A) while the micelle solution (A) was stirred well. After the completion of the dropwise addition, stirring was continued for 30 minutes.

(3) Then, 7.5 mL of tetraethoxysilane (TEOS) was added to the mixed liquid thus obtained while the mixed liquid was stirred, and the stirring was continued for 1 day. In this step, silica layers were formed on surfaces of iron-containing particles in the mixed liquid.

(4) The solution thus obtained was set in a centrifugal machine and was subjected to a centrifugal process for 30 minutes at revolutions per minute of 4500 rpm to collect a deposit. The deposit thus collected was washed multiple times with ethanol.

(5) The deposit thus obtained was dried, and thereafter was placed in a baking furnace under an ambient atmosphere and subjected to a heating treatment at 1150° C. for 4 hours.

(6) A powder after the heating treatment was dispersed into a NaOH aqueous solution having a concentration of 2 mol/L, followed by stirring for 24 hours to remove the silica layers on the surfaces of the particles. Thereafter, filtrating⋅water washing⋅drying was conducted to obtain ε-Fe₂O₃ particles. In addition, as a result of analyzing the crystal structure of the ε-Fe₂O₃ particles thus obtained with X-ray diffraction (XRD), the diffraction peak of ε-Fe₂O₃ was observed, and a diffraction peak derived from any other crystal structure was not observed.

The ε-Fe₂O₃ particles thus obtained were dispersed into an aqueous solution. Since the particle size increases due to aggregation in this state, the particles were coarsely crushed using a roll mill to have an average particle size of 64 nm. Further, the particles were finely ground using a homogenizer to have an average particle size of 42 nm. Furthermore, the particles were filtrated using a filter to obtain particles having an average particle size of about 36 nm.

(Fabrication of Dispersion Solution)

First, 3 g of iron(II) chloride hydrate (FeCl₂.4H₂O) was weighted and dissolved into 75 mL of pure water to obtain an aqueous solution of iron chloride. Next, 0.36 g of ε-Fe₂O₃ particles was weighted and added to the aqueous solution of iron chloride to fabricate a dispersion in which the particles were sufficient dispersed using an ultrasonic disperser.

(Precipitation of Fe by Reduction Processing)

First, 2 g of sodium tetrahydroborate (NaBH₄), which is a reductant, was weighted and was dissolved into 20 mL of pure water to prepare a reductant solution. Next, the reductant solution was added to the above-described dispersion while stirring the dispersion. In this way, iron(II) chloride was reduced to precipitate α-Fe containing a plurality of ε-Fe₂O₃ particles. Note that NaBH₄ was added while being atomized into a mist of several 100 μL by a spray device so as to reduce the particle size as much as possible. When the particle size of α-Fe in the composite particles thus obtained was observed using a scanning electron microscope (SEM), the particle size of α-Fe was 50 nm to 70 nm. Note that the observation was conducted with the magnification of the SEM being set to 50,000 times to 100,000 times. The same magnification was applied to the following Examples as well.

(Drying⋅Thermal Treatment Step)

Water in the aqueous solution containing α-Fe and ε-Fe₂O₃ particles was replaced with ethanol, and after the drying process, 1 g of the composite particles of α-Fe and ε-Fe₂O₃ particles was processed using a pressure molding machine with 10 MPa to fabricate a molded body. Next, the molded body thus obtained was set in an electric furnace and was subjected to a heating treatment. For the primary burning, nitrogen gas was used as the atmosphere gas and the flow rate of the gas was set to 300 sccm. The temperature during the heating treatment was set to 260° C., and the molded body was held at 260° C. for 5 hours and then was cooled down to room temperature. After cooled down to room temperature, the molded body was coarsely crushed using a planetary ball mill under a nitrogen gas atmosphere. The powder obtained by the coarse crushing was set in the electric furnace again, and was subjected to the heating treatment at 400° C. for 3 hours under a nitrogen atmosphere as the secondary burning to obtain a nanocomposite magnetic particle material.

(Analysis on Structure of Composite Magnetic Material)

As a result of analyzing the crystal structure of the composite magnetic material thus obtained with XRD, the diffraction peak of ε-Fe₂O₃ and the diffraction peak of α-Fe were observed, and a diffraction peak derived from any other crystal structure was not observed.

In addition, as a result of observing the cross-section of the particle-shaped composite magnetic material with a scanning electron microscope (SEM), a sea-island structure in which a plurality of islands containing ε-Fe₂O₃ were present in a sea (continuous body) containing α-Fe was observed. When the inter-island distances were calculated from 10 points in the observation image, and the average inter-island distance and the standard deviation thereof were calculated, the average inter-island distance was 22 nm and the standard deviation was 6 nm.

(Evaluation of Magnetic Properties of Composite Magnetic Material)

The magnetic properties (remanent magnetization and coercive force) of the composite magnetic material were evaluated. The result of the evaluation is shown in the following Table 1. Note that the magnetic properties are indicated by values normalized with respect to Comparative Example 5 which is described later.

### Example 2

In Example 2, Fe(OH)₃ particles were precipitated by adding ammonia water to a dispersion solution obtained by dispersing ε-Fe₂O₃ particles in a solution in which iron(III) nitrate enneahydrate (Fe(NO₃)₃.9H₂O) was dissolved to change pH. In this way, composite particles of Fe(OH)₃ and ε-Fe₂O₃ particles were formed. Thereafter, a composite magnetic material having a sea-island structure in which Fe was a sea and ε-Fe₂O₃ particles were islands was fabricated by reducing Fe(OH)₃ with a hydrogen gas into Fe.

(Fabrication of Dispersion Solution Containing Ions of Soft Magnetic Material)

First, 6 g of Fe(NO₃)₃.9H₂O was weighted and dissolved into 75 mL of pure water to obtain an aqueous solution of iron nitrate. Next, 0.36 g of ε-Fe₂O₃ particles was weighted and added to the aqueous solution of iron nitrate to fabricate a dispersion in which the particles were sufficiently dispersed using an ultrasonic disperser.

(Precipitation of Precursor Particles)

First, 75 mL of 28% ammonia water was added to the above-described dispersion while stirring the dispersion to precipitate Fe(OH)₃, which was precursor particles, so that composite particles with ε-Fe₂O₃ particles were formed. When the particle size of the iron hydroxide particles in the composite particles thus obtained was observed with a scanning electron microscope (SEM), the particles were of 10 nm to 20 nm.

(Drying⋅Thermal Treatment Step)

Water in the aqueous solution containing Fe(OH)₃ and ε-Fe₂O₃ particles was replaced with ethanol, and after the drying process, 1 g of the composite particles of Fe(OH)₃ and ε-Fe₂O₃ particles was processed using the pressure molding machine with 10 MPa to fabricate a molded body. Next, the molded body thus obtained was set in the electric furnace and was subjected to a heating treatment. For the primary burning, a mixed gas of 2% hydrogen-98% nitrogen was used as the atmosphere gas and the flow rate of the mixed gas was set to 300 sccm. The temperature during the heating treatment was set to 260° C., and the molded body was held at 260° C. for 5 hours and then was cooled down to room temperature. After cooled down to room temperature, the molded body was coarsely crushed using the planetary ball mill under a nitrogen gas atmosphere. The powder obtained by the coarse crushing was set in the electric furnace again, and was subjected to the heating treatment at 500° C. for 3 hours under a mixed gas (2% H₂-98% N₂) atmosphere of hydrogen and nitrogen as the secondary burning to reduce Fe(OH)₃ into α-Fe, so that a nanocomposite magnetic particle material was obtained.

(Analysis on Structure of Composite Magnetic Material)

As a result of analyzing the crystal structure of the composite magnetic material thus obtained with XRD, the diffraction peak of ε-Fe₂O₃ and the diffraction peak of α-Fe were observed, and a diffraction peak derived from any other crystal structure was not observed.

In addition, as a result of observing the cross-section of the particle-shaped composite magnetic material with the scanning electron microscope (SEM), a sea-island structure in which a plurality of islands containing ε-Fe₂O₃ were present in a sea (continuous body) containing α-Fe was observed. ε-Fe₂O₃ was distributed in substantially the entirety of α-Fe. When the inter-island distances were calculated from 10 points in the observation image, and the average inter-island distance and the standard deviation thereof were calculated, the average inter-island distance was 18 nm and the standard deviation was 4 nm. In addition, the particle size of ε-Fe₂O₃, which was the islands, was 30 nm.

(Evaluation of Magnetic Properties of Composite Magnetic Material)

The magnetic properties (remanent magnetization and coercive force) of the composite magnetic material thus obtained were evaluated using a vibrating-sample magnetometer. The result of the evaluation is shown in Table 1. Note that the magnetic properties are indicated by values specified with respect to Comparative Example 5 which is described later.

### Example 3

In Example 3, Fe₃O₄ particles were precipitated by adding ammonia water to a dispersion solution obtained by dispersing ε-Fe₂O₃ particles in a solution in which iron(II) chloride hydrate (FeCl₂.4H₂O) was dissolved to change pH, so that composite particles of Fe₃O₄ and ε-Fe₂O₃ particles were formed. Thereafter, a composite magnetic material having a sea-island structure in which Fe was a sea and Fe₂O₃ particles were islands was fabricated by reducing Fe₃O₄ with a hydrogen gas into Fe.

(Fabrication of Dispersion Solution)

First, 3 g of FeCl₂.4H₂O was weighted and dissolved into 75 mL of pure water to obtain an aqueous solution of iron chloride. Next, 0.36 g of ε-Fe₂O₃ particles obtained in the same manner as in Example 1 was weighted and added to the aqueous solution of iron chloride to fabricate a dispersion in which the particles were sufficiently dispersed using an ultrasonic disperser.

(Precipitation of Precursor Particles)

First, 75 mL of 28% ammonia water was added to the above-described dispersion while stirring the dispersion to precipitate Fe₃O₄, which was precursor particles, so that the composite particles with ε-Fe₂O₃ particles were formed. When the particle size of the Fe₃O₄ particles in the composite particles thus obtained was observed with a scanning electron microscope (SEM), the particles were of 50 nm to 80 nm.

(Drying⋅Thermal Treatment Step)

Water in the aqueous solution containing Fe₃O₄ and ε-Fe₂O₃ particles was replaced with ethanol, and after the drying process, 1 g of the composite particles of Fe₃O₄ and ε-Fe₂O₃ particles was processed using the pressure molding machine with 10 MPa to fabricate a molded body. Next, the molded body thus obtained was set in the electric furnace and was subjected to a heating treatment. For the primary burning, a mixed gas of 2% hydrogen-98% nitrogen was used as the atmosphere gas and the flow rate of the mixed gas was set to 300 sccm. The temperature during the heating treatment was set to 260° C., and the molded body was held at 470° C. for 5 hours and then was cooled down to room temperature. After cooled down to room temperature, the molded body was coarsely crushed using the planetary ball mill under a nitrogen gas atmosphere. The powder obtained by the coarse crushing was set in the electric furnace again, and was subjected to the heating treatment at 470° C. for 3 hours under a mixed gas (2% H₂-98% N₂) atmosphere of hydrogen and nitrogen as the secondary burning to reduce Fe₃O₄ into α-Fe, so that a nanocomposite magnetic particle material was obtained.

(Analysis on Structure of Composite Magnetic Material)

As a result of analyzing the crystal structure of the composite magnetic material thus obtained with XRD, the diffraction peak of ε-Fe₂O₃ and the diffraction peak of α-Fe were observed, and a diffraction peak derived from any other crystal structure was not observed.

In addition, as a result of observing the cross-section of the particle-shaped composite magnetic material with the scanning electron microscope (SEM), a sea-island structure in which a plurality of islands containing ε-Fe₂O₃ were present in a sea (continuous body) containing α-Fe was observed. ε-Fe₂O₃ was distributed in substantially the entirety of α-Fe. When the inter-island distances were calculated from 10 points in the observation image, and the average inter-island distance and the standard deviation thereof were calculated, the average inter-island distance was 45 nm and the standard deviation was 12 nm. In addition, the particle size of ε-Fe₂O₃, which was the islands, was 20 nm.

(Evaluation of Magnetic Properties of Composite Magnetic Material)

The magnetic properties (remanent magnetization and coercive force) of the composite magnetic material thus obtained were evaluated using the vibrating-sample magnetometer. The result of the evaluation is shown in Table 1. Note that the magnetic properties are indicated by values specified with respect to Comparative Example 5 which is described later.

### Example 4

In Example 4, like Example 3, Fe₃O₄ particles were precipitated by adding ammonia water to a dispersion solution obtained by dispersing ε-Fe₂O₃ particles in a solution in which iron(II) chloride hydrate (FeCl₂.4H₂O) was dissolved to change pH, so that composite particles of Fe₃O₄ and ε-Fe₂O₃ particles were formed. Thereafter, a composite magnetic material having a sea-island structure in which Fe was a sea and Fe₂O₃ particles were islands was fabricated by reducing Fe₃O₄ with a hydrogen gas into Fe. Note that in Example 4, the magnetic material was fabricated while the particle size of the Fe₃O₄ particles precipitated was reduced as compared with Example 3.

(Fabrication of Dispersion Solution)

First, 1.5 g of FeCl₂.4H₂O was weighted and dissolved into 150 mL of pure water to obtain an aqueous solution of iron chloride. Next, 0.18 g of ε-Fe₂O₃ particles obtained in the same manner as in Example 1 was weighted and added to the aqueous solution of iron chloride to fabricate a dispersion in which the particles were sufficiently dispersed using the ultrasonic disperser.

(Precipitation of Precursor Particles)

First, 75 mL of 28% ammonia water was added to the above-described dispersion while stirring the dispersion to precipitate Fe₃O₄, which was precursor particles, so that the composite particles with ε-Fe₂O₃ particles were formed. When the particle size of the Fe₃O₄ particles in the composite particles thus obtained was observed with the scanning electron microscope (SEM), the particles were of 10 nm to 30 nm.

(Drying⋅Thermal Treatment Step)

Water in the aqueous solution containing Fe₃O₄ and ε-Fe₂O₃ particles was replaced with ethanol, and after the drying process, 0.5 g of the composite particles of Fe₃O₄ and ε-Fe₂O₃ particles was processed using the pressure molding machine with 10 MPa to fabricate a molded body. Next, the molded body thus obtained was set in the electric furnace and was subjected to a heating treatment. For the primary burning, a mixed gas of 2% hydrogen-98% nitrogen was used as the atmosphere gas and the flow rate of the mixed gas was set to 300 sccm. The temperature during the heating treatment was set to 260° C., and the molded body was held at 260° C. for 5 hours and then was cooled down to room temperature. After cooled down to room temperature, the molded body was coarsely crushed using the planetary ball mill under a nitrogen gas atmosphere. The powder obtained by the coarse crushing was set in the electric furnace again, and was subjected to the heating treatment at 450° C. for 3 hours under a mixed gas (2% H₂-98% N₂) atmosphere of hydrogen and nitrogen as the secondary burning to reduce Fe₃O₄ into α-Fe, so that a nanocomposite magnetic particle material was obtained.

(Analysis on Structure of Composite Magnetic Material)

As a result of analyzing the crystal structure of the composite magnetic material thus obtained with XRD, the diffraction peak of ε-Fe₂O₃ and the diffraction peak of α-Fe were observed, and a diffraction peak derived from any other crystal structure was not observed.

In addition, as a result of observing the cross-section of the particle-shaped composite magnetic material with the scanning electron microscope (SEM), a sea-island structure in which a plurality of islands containing ε-Fe₂O₃ were present in a sea (continuous body) containing α-Fe was observed. ε-Fe₂O₃ was distributed in substantially the entirety of α-Fe. When the inter-island distances were calculated from 10 points in the observation image, and the average inter-island distance and the standard deviation thereof were calculated, the average inter-island distance was 20 nm and the standard deviation was 6 nm. In addition, the particle size of ε-Fe₂O₃, which was the islands, was 20 nm.

(Evaluation of Magnetic Properties of Composite Magnetic Material)

The magnetic properties (remanent magnetization and coercive force) of the composite magnetic material thus obtained were evaluated using the vibrating-sample magnetometer. The result of the evaluation is shown in Table 1. Note that the magnetic properties are indicated by values specified with respect to Comparative Example 5 which is described later.

### Example 5

A nanocomposite magnetic particle material having a sea-island structure in which α-Fe was a sea and ε-Fe₂O₃ particles were islands was fabricated in the same manner as that in Example 1 except that an external magnetic field of 20 kOe was applied when a molded body was fabricated in Example 1. When the crystal structure and the crystal orientation axis were observed with XRD and TEM, the crystal structure of ε-Fe₂O₃ had a cuboid-shape (Pna21) and the lattice constants were such that the a-axis was 5.1 angstrom, the b-axis was 8.7 angstrom, and the c-axis was 9.4 angstrom. Among these, in the c-axis, which is the easy magnetization axis, a region of ±8 degrees or less accounted for 80% or more in volume fraction.

In addition, the crystal structure of α-Fe was a body-centered cubic structure and the lattice constant was about 2.9 angstrom. In the a-axis, which is the easy magnetization axis, (the b-axis and the c-axis are the same), a region of ±9% or less accounted for 80% or more in volume fraction. The angle between the easy magnetization axis of Fe₂O₃ and the easy magnetization axis of α-Fe was approximately ±6 degrees or less.

A result of evaluating the magnetic properties (remanent magnetization and coercive force) of the composite magnetic material with the vibrating-sample magnetometer is shown in Table 1. Note that the magnetic properties are indicated by values specified with respect to Comparative Example 5 which is described later.

### Example 6

A composite magnetic material having a diameter of 10 mm was fabricated in the same manner as in Example 1 except that the pressure was changed from 10 MPa to 50 MPa when a molded body was fabricated with the pressure molding machine in Example 1. The void ratio of the composite magnetic material was measured to be 7% or less. Regarding the measurement of the void ratio, the relative density of the solidified body was measured as follows: the surface of the solidified body was subjected to emery paper and buffing, then a resin was applied to the surface and the solidified body was immersed in pure water, the specific gravity was calculated from the buoyancy the solidified body received (Archimedian method), and expressed as a ratio to the theoretical specific gravity.

The magnetic properties (remanent magnetization and coercive force) of the composite magnetic material were evaluated. The result of the evaluation is shown in Table 1. Note that the magnetic properties are indicated by values specified with respect to Comparative Example 5 which is described later.

### Example 7

By the same method as indicated in Example 1, a composite magnetic material having a sea-island structure in which Fe was a sea and ε-Fe₂O₃ particles were islands was fabricated by dispersing ε-Fe₂O₃ particles into a solution in which iron(II) chloride hydrate (FeCl₂.4H₂O) was dissolved and adding NaBH₄, which is a reductant, to precipitate Fe. Note however that in order to reduce the distance between the islands containing ε-Fe₂O₃, the composite magnetic material was fabricated under a condition where the particle size of Fe precipitated was reduced. Note that the ε-Fe₂O₃ particles were fabricated under the same conditions as those in Example 1.

(Fabrication of Dispersion Solution)

First, 1.5 g of iron(II) chloride hydrate (FeCl₂.4H₂O) was weighted and dissolved into 75 mL of pure water to obtain an aqueous solution of iron chloride. Next, 0.36 g of ε-Fe₂O₃ particles was weighted and added to the aqueous solution of iron chloride to fabricate a dispersion in which the particles were sufficiently dispersed using the ultrasonic disperser.

(Precipitation of Fe Having Reduced Particle Size)

First, 2 g of sodium tetrahydroborate (NaBH₄), which is a reductant, was weighted and dissolved into 20 mL of pure water to prepare a reductant solution. Next, the above-described dispersion was heated to be stabilized at 95° C. with a water bath while stirring. Next, the reductant solution was added while being atomized by the spray device. In this way, iron(II) chloride was reduced to precipitate α-Fe in the form containing a plurality of ε-Fe₂O₃ particles. Note that NaBH₄ was added in the form of a mist of around 0.1 μL, which was further smaller than that in Example 1. When the particle size of α-Fe in the composite particles thus obtained was observed with the scanning electron microscope (SEM), the particle size of α-Fe was 30 nm to 50 nm.

(Drying⋅Thermal Treatment Step)

In the next drying⋅thermal treatment step, a composite magnetic material was fabricated under the same conditions as those in Example 1.

(Analysis on Structure of Composite Magnetic Material)

As a result of analyzing the crystal structure of the composite magnetic material thus obtained with XRD, the diffraction peak of ε-Fe₂O₃ and the diffraction peak of α-Fe were observed, and a diffraction peak derived from any other crystal structure was not observed.

In addition, as a result of observing the cross-section of the particle-shaped composite magnetic material with the scanning electron microscope (SEM), a sea-island structure in which a plurality of islands containing ε-Fe₂O₃ were present in a sea (continuous body) containing α-Fe was observed. When the inter-island distances were calculated from 10 points in the observation image, and the average inter-island distance and the standard deviation thereof were calculated, the average inter-island distance was 18 nm and the standard deviation was 5 nm.

(Evaluation of Magnetic Properties of Composite Magnetic Material)

The magnetic properties (remanent magnetization and coercive force) of the composite magnetic material were evaluated. The result of the evaluation is shown in the following Table 1. Note that the magnetic properties are indicated by values specified with respect to Comparative Example 5 which is described later.

### Example 8

In this Example, a composite magnetic material having a sea-island structure in which Fe was a sea and ε-Fe₂O₃ particles were islands was fabricated in the same manner as in Example 1 except that the method was different in the step of forming a dispersion solution and the step of precipitating Fe particles by reduction. Note however that in order to reduce the distance between the islands containing ε-Fe₂O₃, the composite magnetic material was fabricated under a condition where the particle size of Fe precipitated was reduced. Note that the ε-Fe₂O₃ particles were fabricated under the same conditions as those in Example 1.

(Fabrication of Dispersion Solution)

First, 1.62 g of iron(II) bromide (FeBr₂) was weighted and dissolved into 150 mL of methanol to obtain a methanol solution of iron bromide. Next, 0.36 g of ε-Fe₂O₃ particles was weighted and added to the methanol solution of iron bromide to fabricate a dispersion in which the particles were sufficiently dispersed using the ultrasonic disperser.

(Precipitation of Fe Particles by Reduction)

First, 2 g of sodium tetrahydroborate (NaBH₄), which is a reductant, was weighted and dissolved into 20 mL of methanol which was subjected to a dehydration process, to prepare a reductant solution. Next, the reductant solution was added dropwise to the above-described dispersion while stirring the dispersion. In this way, iron(II) bromide was reduced to precipitate α-Fe in the form containing a plurality of ε-Fe₂O₃ particles. When the particle size of α-Fe in the composite particles thus obtained was observed with the scanning electron microscope (SEM), the particle size of α-Fe was 10 nm to 20 nm. Note that the ε-Fe₂O₃ particles were fabricated under the same conditions as those in Example 1 except that the dispersion was conducted with methanol which was subjected to the dehydration process. Since the particle size increases due to aggregation in this state, the particles were coarsely crushed using the roll mill to have an average particle size or 64 nm. Further, the particles were finely ground using the homogenizer to have an average particle size of 42 nm. Furthermore, the particles were filtrated using the filter to have an average particle size of about 36 nm.

(Drying⋅Thermal Treatment Step)

In the next drying⋅thermal treatment step, a composite magnetic material was fabricated under the same conditions as those in Example 1.

(Analysis on Structure of Composite Magnetic Material)

As a result of analyzing the crystal structure of the composite magnetic material thus obtained with XRD, the diffraction peak of ε-Fe₂O₃ and the diffraction peak of α-Fe were observed, and a diffraction peak derived from any other crystal structure was not observed.

In addition, as a result of observing the cross-section of the particle-shaped composite magnetic material with the scanning electron microscope (SEM), a sea-island structure in which a plurality of islands containing ε-Fe₂O₃ were present in a sea (continuous body) containing α-Fe was observed. When the inter-island distances were calculated from 10 points in the observation image, and the average inter-island distance and the standard deviation thereof were calculated, the average inter-island distance was 12 nm and the standard deviation was 4 nm.

(Magnetism of Composite Magnetic Material)

The magnetic properties (remanent magnetization and coercive force) of the composite magnetic material were evaluated. The result of the evaluation is shown in the following Table 1. Note that the magnetic properties are indicated by values specified with respect to Comparative Example 5 which is described later.

### Example 9

By the same method as indicated in Example 1, a composite magnetic material having a sea-island structure in which Fe was a sea and ε-Fe₂O₃ particles were islands was fabricated by dispersing ε-Fe₂O₃ particles into a solution in which iron(II) chloride hydrate (FeCl₂.4H₂O) was dissolved and adding NaBH₄, which is a reductant, to precipitate Fe. Note however that in order to reduce the distance between the islands containing ε-Fe₂O₃, the composite magnetic material was fabricated under a condition where the particle size of Fe precipitated was reduced. Note that the ε-Fe₂O₃ particles were fabricated under the same conditions as those in Example 1. This Example is different from Example 8 in that pulsed electric current sintering was conducted in the drying⋅thermal treatment step.

(Fabrication of Dispersion Solution)

First, 1.62 g of iron(II) bromide (Fe Bra) was weighted and dissolved into 150 ml of methanol to obtain a methanol solution of iron bromide. Next, 0.36 g of ε-Fe₂O₃ particles was weighted and added to the methanol solution of iron bromide to fabricate a dispersion in which the particles were sufficiently dispersed using the ultrasonic disperser.

(Precipitation of Fe Particles by Reduction)

First, 2 g of sodium tetrahydroborate (NaBH₄), which is a reductant, was weighted and dissolved into 20 mL of methanol which was subjected to a dehydration process, to prepare a reductant solution. Next, the reductant solution was added dropwise to the above-described dispersion while stirring the dispersion. In this way, iron(II) bromide was reduced to precipitate α-Fe in the form containing a plurality of ε-Fe₂O₃ particles. When the particle size of α-Fe in the composite particles thus obtained was observed with the scanning electron microscope (SEM), the particle size of α-Fe was 10 nm to 20 nm. Note that the ε-Fe₂O₃ particles were fabricated under the same conditions as those in Example 1 except that the dispersion was conducted with methanol which was subjected to the dehydration process. Since the particle size increases due to aggregation in this state, the particles were coarsely crushed using the roll mill to have an average particle size or 64 nm. Further, the particles were finely ground using the homogenizer to have an average particle size of 42 nm. Furthermore, the particles were filtrated using the filter to have an average particle size of about 36 nm.

(Drying⋅Thermal Treatment Step)

In the next drying⋅thermal treatment step, a sintered magnet was fabricated by the following procedure.

In a glovebox held in an argon atmosphere, methanol was evaporated from a methanol slurry containing ε-Fe₂O₃ particles and α-Fe particles to obtain a composite magnetic material powder. Then, 0.6 g of the composite magnetic material powder was weighted and packed in a die set made of graphite and having an inner diameter of 10 mm. The die set was set in a pulsed electric current sintering device equipped with a pressurizing mechanism (LABOX-650F: manufactured by SinterLand Inc.) without being exposed to the atmosphere.

Subsequently, the inside of the sintering chamber was set to a vacuum atmosphere of 2 Pa or less, and then, a compression pressure of 60 MPa was loaded on, and immediately unloaded from, the composite magnetic material powder. A compression pressure of 60 MPa was applied again, and the temperature was increased from room temperature to 90° C. at a temperature increase rate of 50° C./min while this pressure was maintained. Once the temperature reached 90° C., cooling was conducted without holding the temperature. After it was confirmed that the temperature was cooled down to room temperature, the pressure was returned to the atmospheric pressure and the die set was taken out.

(Analysis on Structure of Composite Magnetic Material)

As a result of analyzing the crystal structure of the composite magnetic material thus obtained with XRD, the diffraction peak of ε-Fe₂O₃ and the diffraction peak of α-Fe were observed, and a diffraction peak derived from any other crystal structure was not observed.

In addition, as a result of observing the cross-section of the particle-shaped composite magnetic material with the scanning electron microscope (SEM), a sea-island structure in which a plurality of islands containing ε-Fe₂O₃ were present in a sea (continuous body) containing α-Fe was observed. When the inter-island distances were calculated from 10 points in the observation image, and the average inter-island distance and the standard deviation thereof were calculated, the average inter-island distance was 11 nm and the standard deviation was 3 nm.

(Evaluation of Magnetic Properties of Composite Magnetic Material)

The magnetic properties (remanent magnetization and coercive force) of the composite magnetic material were evaluated. The result of the evaluation is shown in the following Table 1. Note that the magnetic properties are indicated by values specified with respect to Comparative Example 5 which is described later.

Comparative Examples for comparison with the above-described Examples are described.

### Comparative Example 1

In Comparative Example 1, α-Fe nanoparticles and ε-Fe₂O₃ particles were fabricated separately, and these were mixed and subjected to a thermal treatment to fabricate a composite magnetic material containing the α-Fe particles and the ε-Fe₂O₃ particles.

(Fabrication of α-Fe Nanoparticles)

α-Fe nanoparticles, which were a soft magnetic material, were fabricated by the following procedure.

First, 6 g of iron(III) nitrate enneahydrate (Fe(NO₃)₃.9H₂O) was weighted and dissolved into 75 mL of pure water to obtain an aqueous solution of iron nitrate. The aqueous solution of iron nitrate was added to 75 mL of 28% ammonia water while the ammonia water was stirred to precipitate iron hydroxide (Fe(OH)₃), which was precursor particles. The iron hydroxide thus precipitated was collected through filter filtration and sufficiently washed with pure water, followed by vacuum drying to obtain iron hydroxide nanoparticles. As a result of measuring the particle size of the iron hydroxide nanoparticles thus obtained with dynamic light scattering (DLS), the average particle size based on volume was 8 nm.

Next, the iron hydroxide nanoparticles obtained were put into an alumina crucible and the iron hydroxide nanoparticles was subjected to a heating treatment under a reduction atmosphere to obtain α-Fe nanoparticles. A mixed gas of 2% hydrogen-98% nitrogen was used as the atmosphere gas for the heating treatment and the flow rate of the mixed gas was set to 300 sccm. The temperature during the heating treatment was set to 500° C., and the nanoparticles were held at 500° C. for 5 hours and then were cooled down to room temperature. As a result of measuring the particle size of the α-Fe nanoparticles thus obtained with DLS, the average particle size based on volume was 25 nm. In addition, as a result of analyzing the crystal structure of the α-Fe nanoparticles obtained with XRD, the diffraction peak of the α-Fe (alpha iron) was observed, and a diffraction peak derived from any other crystal structure was not observed.

(Fabrication of Composite Magnetic Material)

First, 0.48 g and 0.2 g respectively of the α-Fe nanoparticles and the ε-Fe₂O₃ particles fabricated by the above-described methods were weighted and mixed using the planetary ball mill under a nitrogen gas atmosphere. Next, this mixed powder was processed using the pressure molding machine with 10 MPa to obtain a molded body. The molded body thus obtained was set in the electric furnace and as the primary burning, was subjected to a heating treatment at 260° C. for 5 hours under a mixed gas (2% H₂-98% N₂) atmosphere of hydrogen and nitrogen. After cooled down to room temperature, the molded body was coarsely crushed using the planetary ball mill under a nitrogen gas atmosphere. The powder obtained by the coarse crushing was set in the electric furnace again, and was subjected to the heating treatment at 260° C. for 3 hours under a mixed gas(2% H₂-98% N₂) atmosphere of hydrogen and nitrogen as the secondary burning to obtain a composite magnetic particle material.

(Analysis on Structure of Composite Magnetic Material)

As a result of analyzing the crystal structure of the composite magnetic material thus obtained with XRD, the diffraction peak of ε-Fe₂O₃ and the diffraction peak of α-Fe were observed, and a diffraction peak derived from any other crystal structure was not observed. In addition, as a result of observing the cross-section of the particle-shaped composite magnetic material with the scanning electron microscope (SEM), a structure in which the α-Fe particles and the ε-Fe₂O₃ particles were mixedly present was observed.

(Evaluation of Magnetic Properties of Composite Magnetic Material)

The magnetic properties (remanent magnetization and coercive force) of the composite magnetic material thus obtained were evaluated using the vibrating-sample magnetometer. The result of the evaluation is shown in Table 1. Note that the magnetic properties are indicated by values specified with respect to Comparative Example 5 which is described later.

### Comparative Example 2

In Comparative Example 2, ε-Fe₂O₃ particles were fabricated by the same method as that in Comparative Example 1, and the ε-Fe₂O₃ particles thus fabricated were subjected to reduction processing to fabricate a composite magnetic material containing a core of ε-Fe₂O₃ and a shell of α-Fe.

(Fabrication of Composite Magnetic Material) ε-Fe₂O₃ particles obtained in the same manner as in Comparative Example 1 were set in the electric furnace and subjected to a heating treatment at 350° C. for 30 minutes under a mixed gas (2% H₂-98% N₂) atmosphere of hydrogen and nitrogen. After cooled down to room temperature, the particles were coarsely crushed using the planetary ball mill under a nitrogen gas atmosphere. The powder obtained by the coarse crushing was set in the electric furnace again, and was subjected to a heating treatment at 260° C. for 3 hours under a mixed gas(2% H₂-98% N₂) atmosphere of hydrogen and nitrogen to obtain a composite magnetic material.

(Analysis on Structure of Composite Magnetic Material)

As a result of analyzing the crystal structure of the composite magnetic material thus obtained with XRD, the diffraction peak of ε-Fe₂O₃ and the diffraction peak of α-Fe were observed, and a diffraction peak derived from any other crystal structure was not observed.

In addition, as a result of observing the cross-section of the particle-shaped composite magnetic material with the scanning electron microscope (SEM), an aggregate having a core shell structure containing a core of ε-Fe₂O₃ and a shell of α-Fe was observed.

(Evaluation of Magnetic Properties of Composite Magnetic Material)

The magnetic properties (remanent magnetization and coercive force) of the composite magnetic material thus obtained were evaluated using the vibrating-sample magnetometer. The result of the evaluation is shown in Table 1. Note that the magnetic properties are indicated by values specified with respect to Comparative Example 5 which is described later.

### Comparative Example 3

In Patent Literature 1, a nanocomposite magnet is obtained by mixing hard magnetic particles and soft magnetic particles. The exchanging force acting between a hard magnetic material and a soft magnetic material is proportional to the contact area. For this reason, it is desirable that the contact area between the hard magnetic material and the soft magnetic material is as large as possible. However, in the case where spherical particles are brought into contact with each other, the contact area is close to zero, so that the exchanging force is very small. Note however that it is known that when a powder, which is an aggregate of particles, is compressed, the contact faces are generated between the particles, so that the void ratio decreases. However, nanoparticles having a particle size of 100 nm or less have a tendency that if the particle size is reduced, the bulk density of the powder lowers, so that it is difficult to reduce the void ratio even with compression.

In Comparative Example 3, a composite magnetic material was fabricated by densifying ε-Fe₂O₃ particles and Fe particles in Comparative Example 1, and the void ratio was measured. ε-Fe₂O₃ particles having an average particle size of 30 nm and Fe particles having an average particle size of 25 nm, formed by the same method as in Comparative Example 1, were washed with pure water, each group of particles was dispersed into an organic acid solution, and these solutions were mixed. The solutions were mixed while being irradiated with an ultrasonic wave for around 40 minutes to form these groups of particles into a nanocomposite. The ratio of volume fractions of ε-Fe₂O₃ particles and Fe particles was set to 4:6. After the mixing with the ultrasonic wave, the nanocomposite particles were collected with a centrifugal machine.

A composite magnetic material having a diameter of 10 mm was fabricated by applying a pressure of 50 MPa to these nanocomposite particles with a compression molding machine. When the void ratio of the composite magnetic material was obtained by the same method as in Example 6, the void ratio was 25.3%.

The magnetic properties (remanent magnetization and coercive force) of the composite magnetic material thus obtained were evaluated using the vibrating-sample magnetometer. The result of the evaluation is shown in Table 1. Note that the magnetic properties are indicated by values specified with respect to Comparative Example 5 which is described later.

### Comparative Example 4

In addition, in the case where a composite magnetic material was fabricated by the same method as in Comparative Example 3 while the molding pressure was changed to 300 MPa, the void ratio of the composite magnetic material was 22.4%.

The magnetic properties (remanent magnetization and coercive force) of the composite magnetic material thus obtained were evaluated using the vibrating-sample magnetometer. The result of the evaluation is shown in Table 1. Note that the magnetic properties are indicated by values specified with respect to Comparative Example 5 which is described later.

### Comparative Example 5

Moreover, in the case where a composite magnetic material was fabricated by the same method as in Comparative Example 3 while the molding pressure was changed to 550 MPa, the void ratio of the composite magnetic material was 21.5%. The magnetic properties (remanent magnetization and coercive force) of the composite magnetic material thus obtained were evaluated using the vibrating-sample magnetometer. The result of the evaluation is shown in Table 1.

### Comparative Example 6

When the crystal structure and the crystal orientation axis of the composite magnetic material of Comparative Example 1 were observed with XRD and TEM in the same manner as in Example 5, the easy magnetization axes of ε-Fe₂O₃ and α-Fe were about ±25 degrees and about ±28 degrees, respectively. Note that Comparative Example 6 is not shown in the following Table 1.

TABLE 1

| | | Solution Containing | | | |
|---|---|---|---|---|---|
| | | Ions of Soft | | Precursor of Soft | Reducing |
| | Structure | Magnetic Material | Reductant | Magnetic Material | Gas |
| Example 1 | Sea-island | FeCl₂ | NaBH₄ | — | — |
| | Structure | | | | |
| Example 2 | Sea-island | Fe(NO₃)₃ | Ammonia | Fe(OH)₃ | 2%H₂—98%N₂ |
| | Structure | | Water | | |
| Example 3 | Sea-island | FeCl₂ | Ammonia | Fe₃O₄ | 2%H₂—98%N₂ |
| | Structure | | Water | | |
| Example 4 | Sea-island | FeCl₂ | Ammonia | Fe₃O₄ (Small | 2%H₂—98%N₂ |
| | Structure | | Water | Particle Diameter) | |
| Example 5 | Sea-island | FeCl₂ | NaBH₄ | — | — |
| | Structure | | | | |
| Example 6 | Sea-island | FeCl₂ | NaBH₄ | — | — |
| | Structure | | | | |
| Example 7 | Sea-island | FeCl₂ | NaBH₄ | — | — |
| | Structure | | | | |
| Example 8 | Sea-island | FeBr₂ | NaBH₄ | — | — |
| | Structure | | | | |
| Example 9 | Sea-island | FeBr₂ | NaBH₄ | — | — |
| | Structure | | | | |
| Comparative | Composite | Fe(NO₃)₃ | Ammonia | Fe(OH)₃ | 2%H₂—98%N₂ |
| Example 1 | Particles | | Water | | |
| Comparative | Core-Shell | — | — | — | 2%H₂—98%N₂ |
| Example 2 | | | | | |
| Comparative | Composite | Fe(NO₃)₃ | Ammonia | Fe(OH)₃ | 2%H₂—98%N₂ |
| Example 3 | Particles | | Water | | |
| Comparative | Composite | Fe(NO₃)₃ | Ammonia | Fe(OH)₃ | 2%H₂—98%N₂ |
| Example 4 | Particles | | Water | | |
| Comparative | Composite | Fe(NO₃)₃ | Ammonia | Fe(OH)₃ | 2%H₂—98%N₂ |
| Example 5 | Particles | | Water | | |

| | | | Magnetic | Average | | | |
|---|---|---|---|---|---|---|---|
| | | | field in | Inter- | | Remanent | Coercive |
| | Molding | | Fabrication | Island | | Magnetization | Force |
| | Pressure | Sintering | of Molded | Distance | Standard | (Normalized | (Normalized |
| | (MPa) | Method | Body (kOe) | (nm) | Deviation | Value) | Value) |
| Example 1 | 10 | Pressureless | 0 | 22 | 6 | 128 | 140 |
| | | Sintering | | | | | |
| Example 2 | 10 | Pressureless | 0 | 18 | 4 | 121 | 124 |
| | | Sintering | | | | | |
| Example 3 | 10 | Pressureless | 0 | 45 | 12 | 114 | 131 |
| | | Sintering | | | | | |
| Example 4 | 10 | Pressureless | 0 | 20 | 6 | 105 | 119 |
| | | Sintering | | | | | |
| Example 5 | 10 | Pressureless | 20 | — | — | 160 | 170 |
| | | Sintering | | | | | |
| Example 6 | 50 | Pressureless | 0 | — | — | 140 | 122 |
| | | Sintering | | | | | |
| Example 7 | 10 | Pressureless | 0 | 18 | 5 | 132 | 143 |
| | | Sintering | | | | | |
| Example 8 | 10 | Pressureless | 0 | 12 | 4 | 165 | 178 |
| | | Sintering | | | | | |
| Example 9 | 60 | Pulsed | 0 | 11 | 3 | 171 | 230 |
| | | Electric | | | | | |
| | | Current | | | | | |
| | | Sintering | | | | | |
| Comparative | 10 | Pressureless | 0 | — | — | 35 | 35 |
| Example 1 | | Sintering | | | | | |
| Comparative | 10 | Pressureless | 0 | — | — | 36 | 40 |
| Example 2 | | Sintering | | | | | |
| Comparative | 50 | Pressureless | 0 | — | — | 47 | 45 |
| Example 3 | | Sintering | | | | | |
| Comparative | 300 | Pressureless | 0 | — | — | 70 | 72 |
| Example 4 | | Sintering | | | | | |
| Comparative | 550 | Pressureless | 0 | — | — | 100 | 100 |
| Example 5 | | Sintering | | | | | |

As shown in Table 1, in Examples 1 to 8, both of the remanent magnetization and the coercive force were improved as compared with Comparative Examples 1 to 5. In addition, as shown in Example 9, when the thermal treatment was conducted by the pulsed electric current sintering, the remanent magnetization and the coercivity were significantly improved. From the above results, it was found that a magnetic material having a high performance can be produced by precipitating soft magnetic material particles from a dispersion that is obtained by dispersing particles containing a hard magnetic material into a solution in which a soft magnetic material is ionized and dissolved.

### Example 10

Motors having different shapes were fabricated based on the inner rotor-type brushless motor illustrated in FIGS. 9A, 9B, and 10. Table 3 shows the outer diameter and the thickness of each magnet 5 illustrated in FIG. 9A and the length of each magnet 5 illustrated in FIG. 9B. Table 4 shows the thickness (cylinder thickness) of each yoke 6 illustrated in FIG. 9A and the thickness (lid thickness) of each moving part (rotor) lid 8 illustrated in FIG. 9B. Table 5 shows the diameter of each shaft 7 illustrated in FIG. 9A and the length of each shaft 7 illustrated in FIG. 9B. In addition, Tables 3, 4, and 5 show the specific gravity and the weight of each part and the weight occupancy thereof in each entire moving part (rotor) 4. Moreover, Table 5 shows the weight of each entire moving part (rotor).

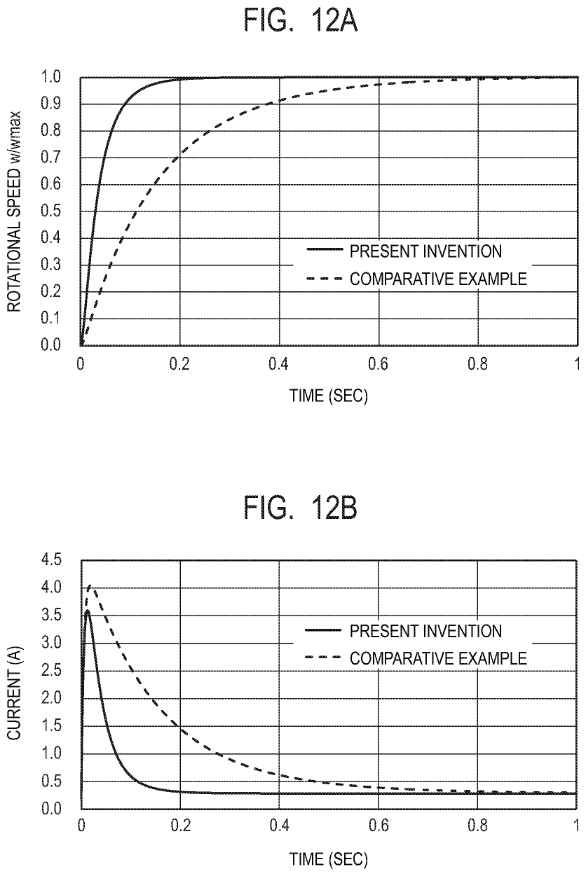

FIG. 12A is a graph illustrating, on the vertical axis, a value w/w max which is obtained by normalizing the rotational speed w of the motor with the maximum rotational speed w max and, on the horizontal axis, the time t from the start of rotation in the case of Example 1 in Tables 3, 4, and 5. In FIG. 12A, the present invention is indicated by a solid line. FIG. 12B is a graph illustrating, on the vertical axis, the consumed current of the motor and, on the horizontal axis, the time t from the start of rotation in the case of Example 1 in Tables 3, 4, and 5. In FIG. 12B, the present invention is indicated by a solid line. The bonded magnet containing the composite magnetic material applied to this Example was a bonded magnet fabricated by mixing a composite magnetic material that contained hard magnetic particles ε-Fe₂O₃ having an average particle size of 5 nm in a volume fraction of 0.4 and had an inter-particle distance of 30 nm and a specific gravity of 6.7 g/cm³ with a resin that had a specific gravity ρp of 1 g/cm³ in a volume fraction Vm=0.7 (volume ratio 7:3). The specific gravity ρb of the bonded magnet applied to this Example was 5 g/cm³.

Table 2 shows the activation time (time taken for the rotational speed w to reach 98% of the maximum speed w max) and the energy required for 1 second. The measurement was conducted with a voltage of 10 V, and the energy was obtained from a current value and an integral value of the voltage for 1 second. As a result, in the motor of the present invention, the activation time was 0.12 seconds and the energy was 4.53 J.

### Comparative Example 7

Results of measurements on a motor having the same structure as that of Example 10 except that the magnet was changed from the magnet of the present invention to a neodymium magnet having the same maximum energy product are shown by dotted lines in FIGS. 12A and 12B. In the motor of Comparative Example, the activation time was 0.60 seconds and the energy was 9.41 J. Hence it was revealed that the motor using the magnet of the present invention in the moving part (rotor) had a faster activation time and a smaller consumed energy (power consumption).

### Example 11

As shown in Table 3, Table 4, and Table 5, a motor having the same structure as that of Example 10 except that the shape was changed was fabricated. The activation time of the motor was 0.35 seconds.

### Example 12

As shown in Table 3, Table 4, and Table 5, a motor having the same structure as that of Example 10 except that the shape was changed was fabricated. The activation time of the motor was 0.42 seconds.

### Comparative Example 8

As shown in Table 3, Table 4, and Table 5, a motor having the same structure as that of Example 11 except that the magnet was changed from the magnet of the present invention to a neodymium magnet having the same maximum energy product was fabricated. The activation time of the motor was 0.81 seconds.

### Comparative Example 9

As shown in Table 3, Table 4, and Table 5, a motor having the same structure as that of Example 12 except that the magnet was changed from the magnet of the present invention to a neodymium magnet having the same maximum energy product was fabricated. The activation time of the motor was 0.76 seconds.

As described above, the activation time of Example 10 was 20% of the activation time of Comparative Example 7, the activation time of Example 11 was 43% of the activation time of Comparative Example 8, and the activation time of Example 12 was 55% of the activation time of Comparative Example 9. Although the rotor weight was different among Examples, in all the Examples, the motor of the present invention had a shorter activation time than those of the motors of Comparative Examples, and the activation time shortening effect became higher in accordance with the weight occupancy in the rotor (rotary part).

TABLE 2

| | Activation time | Energy |
|---|---|---|
| Present invention | 0.12 sec | 4.53 J |
| Known Example | 0.60 sec | 9.41 J |

TABLE 3

| | Magnet | | | | | |
|---|---|---|---|---|---|---|
| | | | | | | Weight |
| | Outer | Thick- | | | | Occu- |
| | Diameter | ness | Length | Density | Weight | pancy |
| | (mm) | (mm) | (mm) | (g/cm³) | (g) | (%) |
| Example 10 | 30 | 12 | 12 | 6.7 | 54.6 | 89.1 |
| Example 11 | 30 | 10 | 12 | 6.7 | 50.5 | 60.1 |
| Example 12 | 30 | 5 | 12 | 6.7 | 31.6 | 38.2 |
| Comparative | 30 | 12 | 12 | 7.6 | 61.9 | 90.3 |
| Example 7 | | | | | | |
| Comparative | 30 | 10 | 12 | 7.6 | 57.3 | 63 |
| Example 8 | | | | | | |

TABLE 4

| | Yoke | | | | |
|---|---|---|---|---|---|
| | Cylinder | Lid | | | Weight |
| | Thickness | Thickness | Density | Weight | Occupancy |
| | (mm) | (mm) | (g/cm³) | (g) | (%) |
| Example 10 | 0 | 0 | 7.85 | 0.0 | 0.0 |
| Example 11 | 2 | 2 | 7.85 | 26.9 | 32.0 |
| Example 12 | 5 | 2 | 7.85 | 44.4 | 53.7 |
| Comparative | 0 | 0 | 7.85 | 0.0 | 0.0 |
| Example 7 | | | | | |
| Comparative | 2 | 2 | 7.85 | 26.9 | 29.6 |
| Example 8 | | | | | |
| Comparative | 5 | 2 | 7.85 | 44.4 | 51.1 |
| Example 9 | | | | | |

TABLE 5

| | Shaft | | | | | |
|---|---|---|---|---|---|---|
| | | | | | Weight | |
| | | | | | Occu- | Rotor |
| | Diameter | Length | Density | Weight | pancy | Weight |
| | (mm) | (mm) | (g/cm³) | (g) | (%) | (g) |
| Example 10 | 6 | 30 | 7.87 | 6.7 | 10.9 | 61.2 |
| Example 11 | 6 | 30 | 7.87 | 6.7 | 7.9 | 84.1 |
| Example 12 | 6 | 30 | 7.87 | 6.7 | 8.1 | 82.6 |
| Comparative | 6 | 30 | 7.87 | 6.7 | 9.7 | 68.6 |
| Example 7 | | | | | | |
| Comparative | 6 | 30 | 7.87 | 6.7 | 7.3 | 90.9 |
| Example 8 | | | | | | |

According to present invention, it is possible to obtain a composite magnetic material having excellent magnetic properties. In addition, using the magnetic material makes it possible to obtain a lightweight magnet having excellent magnetic properties. Then, using such a magnet makes it possible to obtain a lightweight motor having a short activation time and low power consumption.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions

What is claimed is:

1. A composite magnetic material comprising:
a soft magnetic phase including a magnetic material containing a ferromagnetic material including Fe or Co as a main component; and
a plurality of hard magnetic particles present and dispersed in a form of islands in the soft magnetic phase, wherein
the hard magnetic particles have an average particle size of 2 nm or more and include a magnetic material containing a ferrimagnetic material or an antiferromagnetic material as a main component, and
an average distance between adjacent two of the hard magnetic particles is 100 nm or less.

2. The composite magnetic material according to claim 1, wherein
the hard magnetic particles contain ε-Fe₂O₃ as the main component.

3. The composite magnetic material according to claim 1, wherein
the soft magnetic phase contains α-Fe as the main component.

4. The composite magnetic material according to claim 1, wherein
for each of the plurality of hard magnetic particles, an angle made by a direction of an easy magnetization axis of the hard magnetic particle and a certain one direction is 15 degrees or less in the composite magnetic material.

5. The composite magnetic material according to claim 1, wherein
an angle made by a direction of an easy magnetization axis of the soft magnetic phase and a certain one direction is 15 degrees or less over the entire soft magnetic phase present between adjacent two of the hard magnetic particles in the composite magnetic material.

6. The composite magnetic material according to claim 1, wherein
a volume fraction of voids in the composite magnetic material is 20% or less.

7. The composite magnetic material according to claim 1, wherein
a content of a non-magnetic material in the composite magnetic material is 10% or less in volume fraction.

8. The composite magnetic material according to claim 1, wherein
a squareness ratio of a magnetization curve expressed by a relation between an external magnetic field and magnetization is 0.7 or more.

9. The composite magnetic material according to claim 1, wherein
a mixing ratio of the hard magnetic particles and the soft magnetic phase is 0.2 or more and 0.6 or less in volume fraction Vh/(Vs+Vh), where Vs is a volume of the soft magnetic phase and Vh is a volume of the hard magnetic particles.

10. A magnet comprising:
the composite magnetic material according to claim 1.

11. The magnet according to claim 10, wherein
a maximum energy product of the magnet is 170 kJ/m³ or more.

12. The magnet according to claim 10, further comprising
a resin material.

13. The magnet according to claim 12, wherein
a specific gravity is 5 g/cm³ or less.

14. A motor comprising:
a rotor, and
a stator
wherein at least any one of the rotor and the stator is the magnet according to claim 10.

15. A motor unit comprising:
the motor according to claim 14; and
a sequencer that drives in a driving sequence in which a time during which the motor is rotated at a constant speed is twice or less a time during which the motor is accelerated to rotate.

16. A motor unit comprising:
the motor according to claim 14; and
a sequencer that drives in a driving sequence in which positive rotation and negative rotation of the motor are repeated.

17. A method of manufacturing a composite magnetic material containing a soft magnetic material and a hard magnetic material, the soft magnetic material containing at least one transition metal element, the method comprising:
a first step of obtaining a dispersion by dispersing particles containing the hard magnetic material into a solution containing ions containing the transition metal element; and
a second step of precipitating particles containing the transition metal element by adding an additive to the dispersion.

18. The method of manufacturing the composite magnetic material according to claim 17, wherein
the additive is a reductant.

19. The method of manufacturing the composite magnetic material according to claim 17, wherein
the additive is a basic solution, and
in the second step,
pH of the dispersion is changed by adding the basic solution to the dispersion, to precipitate a precursor containing the transition metal element around particles containing the hard magnetic material, and then
the precursor is reduced into the soft magnetic material.

20. The method of manufacturing the composite magnetic material according to claim 17, further comprising:
a third step of conducting a thermal treatment, after the second step.

21. The method of manufacturing the composite magnetic material according to claim 20, wherein
the third step is pulsed electric current sintering.
